(19) United States
(12) Patent Application Publication
(10) Pub. No.: US 2013/0120814 A1
(43) Pub. Date: May 16, 2013

(54) HOLOGRAM REPLICATING METHOD AND HOLOGRAM REPLICATING APPARATUS

(71) Applicants: Sony Corporation, Tokyo (JP); Sony DADC Corporation, Tokyo (JP)

(72) Inventors: Masaki Arai, Kanagawa (JP); Akira Shirakura, Kanagawa (JP)

(73) Assignees: SONY DADC CORPORATION, Tokyo (JP); SONY CORPORATION, Tokyo (JP)

(21) Appl. No.: 13/663,218

(22) Filed: Oct. 29, 2012

(30) Foreign Application Priority Data
Nov. 10, 2011 (JP) 2011-246277
Sep. 6, 2012 (JP) 2012-196329

(51) Int. Cl. G03H 1/12; G03H 1/10

(52) U.S. Cl. 359/11; 359/10

(57) ABSTRACT

A hologram master having a hologram image recorded thereon is brought into intimate contact with a surface of a hologram recording medium containing a photosensitive material directly or via a refractive index adjuster. The hologram image is made to have continuous parallax in at least a first direction with a movement of an eyepoint along the first direction with respect to a normal line when the hologram master is illuminated at a predetermined angle. First laser light is applied onto the hologram master and the hologram recording medium via a diffusion plate configured to diffuse incident light in a second direction. Second laser light is applied onto the hologram recording medium via the hologram master simultaneously with the first laser light. The hologram image recorded on the hologram master and first additional information are recorded on the hologram recording medium.

### CROSS REFERENCES TO RELATED APPLICATIONS

The present application claims priority to Japanese Priority Patent Application JP 2011-246277 filed in the Japan Patent Office on Nov. 10, 2011, Japanese Priority Patent Application JP 2012-196329 filed in the Japan Patent Office on Sep. 6, 2012, the entire content of which is hereby incorporated by reference.

### BACKGROUND

The present disclosure relates to a hologram replicating method and a hologram replicating apparatus. In particular, the present disclosure relates to a replicating method and a replicating apparatus for recording at least two information, each having parallax in a different direction, on a hologram recording medium.

Holograms capable of being stereoscopically displayed have been used for the authentication of credit cards, identification cards, or the like. In recent years, volume holograms have been often used where interference patterns are recorded inside recording layers as differences in refractive index. This is because, in order to forge the volume holograms, high technology is necessary for generating recorded images and recording materials for the volume holograms are not easily available.

However, technologies for replicating the volume holograms have also been improved, and thus more advanced authentication functions and forge preventing countermeasures have been expected. As a method of providing a more advanced authentication function for holograms, one of the present applicants has proposed to perform recording such that different images are reproduced in accordance with the observation directions of the holograms.

For example, Japanese Patent Application Laid-open No. 2010-176116 discloses an image recording medium where different images are reproduced with the movements of an eyepoint when the image recording medium is observed under illumination from a predetermined direction. When the image recording medium is observed under the illumination from the predetermined direction, a first image having continuous parallax is reproduced with the horizontal movement of the eyepoint. On the other hand, with, for example, the vertical movement of the eyepoint, a second image is reproduced at a predetermined angle. The second image is a two-dimensional image such as a number, a symbol, and a combination of characters.

According to Japanese Patent Application Laid-open No. 2010-176116, an incident angle of additional information light with respect to a hologram recording medium is prescribed at the recording of information on the hologram recording medium to prevent a difficulty in observation due to a plurality of recorded images being overlapped with each other (hereinafter referred to as “crosstalk” if necessary). The angle at which a second image is reproduced with maximum brightness at the reproduction of the second image depends on an incident angle of the additional information light.

According to the technology described in Japanese Patent Application Laid-open No. 2010-176116, an incident angle of the additional information light and an incident angle of reference light with respect to the hologram recording medium are selected such that the angle at which a first image is reproduced with maximum brightness does not get so close to the angle at which a second image is reproduced with maximum brightness.

Further, according to Japanese Patent Application Laid-open No. 2010-176116, a diffusion angle of the additional information light with respect to the hologram recording medium is prescribed at the recording of the information on the hologram recording medium. The range of an eyepoint where a second image can be observed depends on a diffusion angle of the additional information light. The intensity of light for reproducing a second image is distributed such that it becomes gradually smaller as the deviation of the angle at which the second image is reproduced with maximum brightness becomes larger.

Here, if there is a steep peak in the distribution of the intensity of the light for reproducing the second image, the range of the eyepoint where the second image can be observed is limited to a very small range, which results in a difficulty in the observation of the second image. In other words, if there is a great change in the intensity of the light for reproducing the second image with the movement of the eyepoint, the crosstalk can be prevented but the observation of the second image becomes difficult.

### SUMMARY

It is desirable that, in an image recording medium where different images are reproduced when an eyepoint is moved in different directions, the respective reproduced images be easily observed.

According to an embodiment of the present disclosure, there is provided a hologram replicating method. In the hologram replicating method, a hologram master having a hologram image recorded thereon is brought into intimate contact with a surface of a hologram recording medium containing a photosensitive material directly or via a refractive index adjuster. The hologram image is made to have continuous parallax in at least a first direction with a movement of an eyepoint along the first direction with respect to a normal line when the hologram master is illuminated at a predetermined angle. First laser light is applied onto the hologram master and the hologram recording medium via a diffusion plate configured to diffuse incident light in a second direction, and second laser light having passed through a first spatial light modulation element configured to modulate incident light based on first additional information is applied onto the hologram recording medium via the hologram master simultaneously with the first laser light. The hologram image recorded on the hologram master and the first additional information are recorded on the hologram recording medium.

According to another embodiment of the present disclosure, there is provided a hologram replicating method. In the hologram replicating method, a hologram master having a hologram image recorded thereon is arranged with respect to a surface of a hologram recording medium. First laser light is applied onto the hologram master and the hologram recording medium via a diffusion plate. Second laser light is modulated based on additional information. The modulated second laser light is applied onto the hologram recording medium via the hologram master.

According to still another embodiment of the present disclosure, there is provided a hologram replicating apparatus including a first application optical system, a diffusion plate, a second application optical system, and a spatial light modulation element.

The first application optical system is configured to apply first laser light onto a hologram master and a hologram recording medium containing a photosensitive material.

The hologram master has a hologram image recorded thereon. The hologram image is made to have continuous parallax in at least a first direction with a movement of an eyepoint along the first direction with respect to a normal line when the hologram master is illuminated at a predetermined angle.

The hologram recording medium is brought into intimate contact with a surface of the hologram master directly or via a refractive index adjuster.

The diffusion plate is arranged between the first application optical system and the hologram recording medium and configured to diffuse incident light in a second direction.

The second application optical system is configured to apply second laser light onto the hologram recording medium via the hologram master.

The spatial light modulation element is arranged between the second application optical system and the hologram master and configured to modulate incident light based on additional information.

In the hologram replicating apparatus, the first laser light and the second laser light are simultaneously applied to record the hologram image recorded on the hologram master and the additional information on the hologram recording medium.

According to yet another embodiment of the present disclosure, there is provided a hologram replicating apparatus including a first application optical system, a diffusion plate, a second application optical system, and a spatial light modulation element.

The first application optical system is configured to apply first laser light onto a hologram master having a hologram image recorded thereon and a hologram recording medium arranged with respect to a surface of the hologram master.

The diffusion plate is arranged between the first application optical system and the hologram recording medium.

The second application optical system is configured to apply second laser light onto the hologram recording medium via the hologram master.

The spatial light modulation element is arranged between the second application optical system and the hologram master and configured to modulate incident light based on additional information.

According to the embodiments of the present disclosure, in order to perform the replication of a hologram image recorded on the hologram master and the recording of a two-dimensional image of additional information on the hologram recording medium, the diffusion plate is arranged between the application optical system for applying reference light and the hologram recording medium. The hologram master has, for example, the hologram image having continuous parallax in the horizontal direction (first direction) recorded thereon.

The diffusion plate arranged between the application optical system for applying the reference light and the hologram recording medium has the function of extending the ranges of the eyepoint where the hologram image (first image) replicated on the hologram recording medium and the two-dimensional image (second image) of the additional information recorded on the hologram recording medium are observed.

Here, according to the embodiments of the present disclosure, the diffusion plate having the property of diffusing the incident light in a predetermined direction is used. The predetermined direction refers to the direction (second direction) different from the movement direction of the eyepoint where the hologram image having continuous parallax is reproduced from the hologram master.

Thus, according to the embodiments of the present disclosure, in the range of the eyepoint where the image replicated or recorded on the hologram recording medium can be observed, the range of the eyepoint in the second direction is mainly extended. That is, the range of the eyepoint where the second image can be observed is mainly extended in the second direction.

According to the embodiments of the present disclosure, the range of the eyepoint where the second image can be observed is extended in the second direction, and a peak in the distribution of the intensity of light for reproducing the second image is reduced. Accordingly, easiness in the observation of the second image is improved.

Moreover, according to the embodiments of the present disclosure, because the diffusion plate is arranged between the application optical system for applying the reference light and the hologram recording medium, the two-dimensional image of the additional information is formed on an approximately-constant flat surface very close to the front surface of the hologram recording medium. Because the two-dimensional image is positioned on the surface of the hologram recording medium, it is possible to prevent the reduced sharpness of a reproduction image and achieve both easiness in the observation of the reproduction image reproduced from the image recording medium and easiness in the manufacturing of the image recording medium even if the second image is a two-dimensional image.

In the present specification, the “hologram recording medium” refers to a recording medium where information has not been recorded in a holographic manner, and the “image recording medium” refers to a recording medium where information has been recorded.

According to at least one embodiment, it is possible to improve easiness in the observation of different images when observing an image recording medium where the respective images are reproduced with the movements of an eyepoint.

These and other objects, features and advantages of the present disclosure will become more apparent in light of the following detailed description of best mode embodiments thereof, as illustrated in the accompanying drawings.

Additional features and advantages are described herein, and will be apparent from the following Detailed Description and the figures.

### BRIEF DESCRIPTION OF THE FIGURES

FIG. 1 is a schematic view showing a configuration example of a hologram replicating apparatus according to a first embodiment;

FIGS. 2A to 2D are views each showing an example of a reproduction image reproduced from an image recording medium obtained by the hologram replicating apparatus according to the embodiment of the present disclosure;

FIG. 3A is a schematic view showing the periphery of a hologram recording medium shown in FIG. 1 in an enlarged manner;

FIG. 3B is a schematic view showing the cross section of an example of a diffusion plate applied to a hologram replicating method according to the embodiment of the present disclosure;

FIG. 3C is a plan view of the diffusion plate shown in FIG. 3B;

FIG. 4 is a schematic view showing a configuration example of a hologram replicating apparatus according to a second embodiment;

FIG. 5 is a schematic view showing a configuration example of a hologram replicating apparatus according to a third embodiment;

FIG. 6 is a schematic view showing a configuration example of a hologram replicating apparatus according to a fourth embodiment;

FIG. 7 is a schematic view showing a configuration example of a hologram replicating apparatus according to a fifth embodiment;

FIG. 8A is a view used for explaining the relationship between a plurality of lenticular shapes and shape parameters in a diffusion plate having a plurality of lenticular-shape structures;

FIGS. 8B and 8C are conceptual views showing a method of measuring the intensity of diffraction light;

FIGS. 9A and 9B are graphs showing measurement results of brightness related to samples;

FIGS. 10A and 10B are graphs showing measurement results of brightness related to the respective samples;

FIGS. 11A and 11B are graphs showing measurement results of brightness related to the respective samples;

FIGS. 12A and 12B are graphs showing measurement results of brightness related to the respective samples;

FIG. 13 is a schematic view showing a configuration example of a hologram replicating apparatus for recording on a hologram recording medium a hologram image having continuous parallax in a horizontal direction and a two-dimensional image having parallax in a vertical direction and serving as a hologram;

FIG. 14A is a schematic view showing a cross section of an example of the hologram recording medium; and

FIGS. 14B to 14D are schematic views showing a photosensitive process of a photopolymerizable photopolymer.

### DETAILED DESCRIPTION

Hereinafter, embodiments of a hologram replicating method and a hologram replicating apparatus will be described. The description will be given in the following order.

(0) Method of Manufacturing Image Recording Medium where Two-Dimensional Image is Recorded in Overlapped State

(Configuration Example of Hologram Replicating Apparatus)

(Position of Two-Dimensional Image)

### (1) First Embodiment

(Configuration Example of Hologram Replicating Apparatus)

(Image Recording Medium)

(Diffusion Plate)

### (2) Second Embodiment

(Configuration Example of Hologram Replicating Apparatus)

### (3) Third Embodiment

(Configuration Example of Hologram Replicating Apparatus)

### (4) Fourth Embodiment

(Configuration Example of Hologram Replicating Apparatus)

### (5) Fifth Embodiment

(Configuration Example of Hologram Replicating Apparatus)

### (6) Modification

Note that the following embodiments are desired concrete examples of the hologram replicating method and the hologram replicating apparatus. In the following description, various technically-desired limitations are added. However, the examples of the hologram replicating method and the hologram replicating apparatus are not limited to the following embodiments unless the present disclosure is particularly limited.

### (0) Method of Manufacturing Image Recording Medium where Two-Dimensional Image is Recorded in Overlapped State

First, the outline of a method of manufacturing an image recording medium where a two-dimensional image is recorded in an overlapped state will be described for facilitating the understanding of the embodiments of the present disclosure. Specifically, the image recording medium is a volume hologram where a hologram image having continuous parallax in a horizontal direction and a two-dimensional image having parallax in a vertical direction and serving as a hologram are recorded.

(Configuration Example of Hologram Replicating Apparatus)

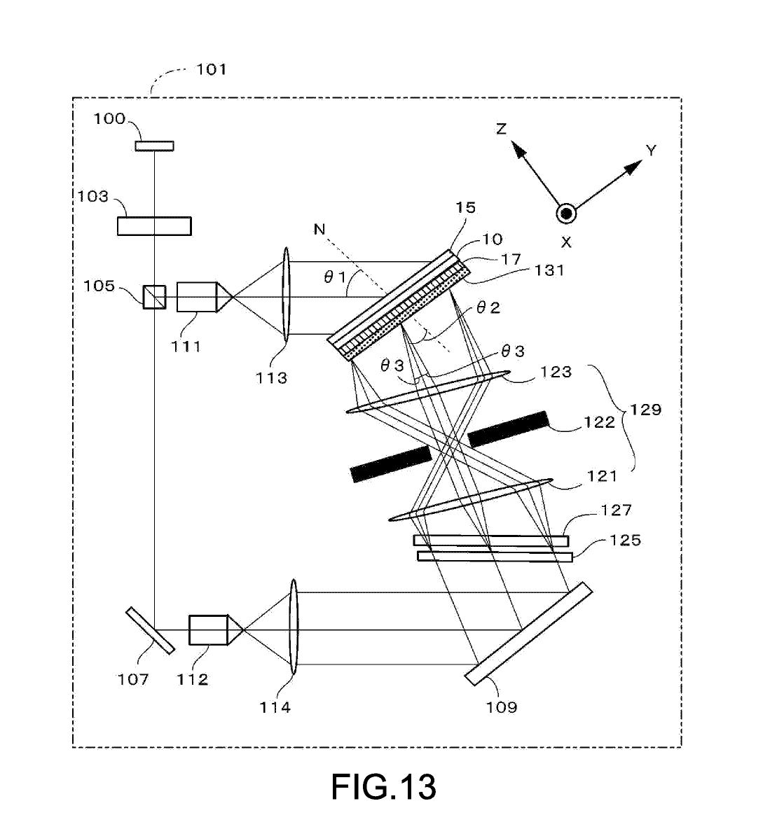

FIG. 13 is a schematic view showing a configuration example of a hologram replicating apparatus for recording on a hologram recording medium a hologram image having continuous parallax in a horizontal direction and a two-dimensional image having parallax in a vertical direction and serving as a hologram.

As shown in FIG. 13, the hologram replicating apparatus 101 schematically has an optical system for applying reference light onto the hologram recording medium 15 and an optical system for applying light modulated by a spatial light modulation element such as a liquid crystal panel 125 onto the same. On the hologram recording medium 15, two interference patterns are recorded in an overlapped state. One of the two interference patterns is an interference pattern formed by the interference between the reference light and diffraction light (reproduction light) emitted from a hologram master 10 when the reference light is applied. The other of the two interference patterns is an interference pattern formed by the interference between additional information light and the reference light.

Next, the outline of the method of manufacturing an image recording medium using the hologram replicating apparatus 101 will be described with reference to FIG. 13.

First, laser light emitted from a laser light source 100 is incident on a polarization beam splitter 105 via a ½ wavelength plate 103. The ½ wavelength plate 103 rotates the polarization plane of the laser light.

Note that the wavelength of the laser light emitted from the laser light source 100 may include a wavelength component of a color necessary for reproducing an image recorded on the hologram master 10 that will be described below. As a wavelength of the laser light emitted from the laser light source 100, a wavelength of about 532 nm is, for example, selected.

Part (e.g., S-polarization component) of the laser light is reflected by the polarization beam splitter 105, and then the reflected laser light is expanded by a spatial filter 111. The laser light emitted from the spatial filter 111 is incident on a collimation lens 113.

Parallel laser light collimated by the collimation lens 113 is applied onto the hologram recording medium 15 having a photosensitive material layer and onto the hologram master 10. At this time, an incident angle θ1 of the laser light incident on the hologram recording medium 15 is set at, for example, 45°. Note that the hologram recording medium 15 and the hologram master 10 are brought into intimate contact with each other directly or via a refractive index adjusting liquid (also referred to as an index matching liquid).

Hereinafter, as shown in FIG. 13, the horizontal direction and the vertical direction of the hologram recording medium 15 will be defined as an X direction and a Y direction, respectively. Further, the direction parallel to a normal line N on the hologram recording medium 15 and facing from the hologram master 10 to the hologram recording medium 15 will be defined as a Z direction.

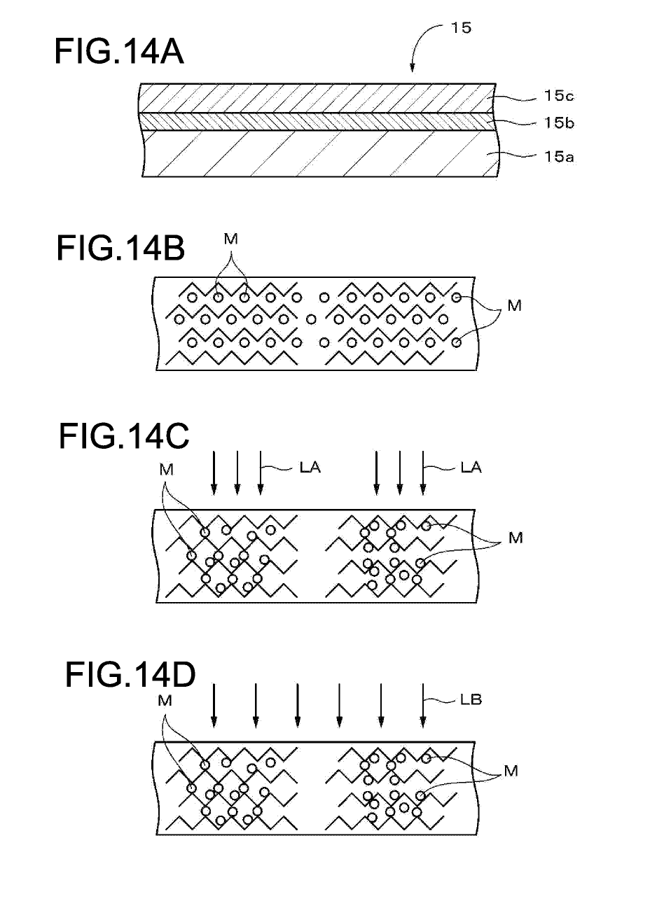

FIG. 14A is a schematic view showing a cross section of an example of the hologram recording medium. As shown in FIG. 14A, the hologram recording medium 15 has a laminated structure where a tape-shaped film base material 15a, a photopolymer layer 15b made of a photopolymerizable photopolymer, and a cover sheet 15c are laminated in the stated order. The hologram recording medium 15 shown in FIG. 14A is a so-called film-applied recording medium.

FIGS. 14B to 14D are schematic views showing a photosensitive process of a photopolymerizable photopolymer. In an initial state of the photopolymerizable photopolymer, monomers M are uniformly dispersed in a matrix polymer as shown in FIG. 14B.

When light LA of about 10 to 400 mJ/cm² is applied onto the photopolymerizable photopolymers shown in FIG. 14C, the monomers M begin to polymerize in an exposure part. Then, with the progress of polymerization, the monomers M move from peripheral areas, which results in a change in the concentration of the monomers M in places. The change in the concentration of the monomers brings about refractive index modulation.

Thereafter, when light LB of about 1000 mJ/cm² is applied onto the entire surface of the photopolymerizable photopolymer as shown in FIG. 14D, the polymerization of the monomers M is completed. The light LB of about 1000 mJ/cm² is, for example, UV (ultraviolet) light or visible light.

As described above, the refractive index of the photopolymerizable photopolymer changes according to incident light. Therefore, the photopolymerizable photopolymer can record an interference pattern formed by the interference between reference light and object light as a change in the refractive index. The hologram recording medium 15 using such a photopolymerizable photopolymer does not have to be subjected to any special development process after being exposed. Therefore, with the use of the photopolymerizable photopolymer in the hologram recording medium 15, the hologram replicating apparatus 101 can be simplified in configuration.

The hologram master 10 is a volume hologram where a holographic stereogram having continuous parallax in the horizontal direction is, for example, recorded. The holographic stereogram may be a holographic stereogram having parallax in both the horizontal and the vertical directions when observed. Further, the hologram master 10 may be a volume hologram where an actually-captured hologram generated by the application of laser light onto an object is recorded. In the following description, the hologram master 10 is a volume hologram where a holographic stereogram having continuous parallax in the horizontal direction is recorded.

When the parallel laser light (reference light) collimated by the collimation lens 113 is applied onto the hologram master 10, reproduction light related to a recorded image is emitted from the hologram master 10.

That is, an interference pattern formed by the interference between the reproduction light from the hologram master 10 and the parallel laser light (reference light) collimated by the collimation lens 113 is recorded on the hologram recording medium 15. In other words, the image (first image) having continuous parallax in the horizontal direction and recorded on the hologram master 10 is replicated on the hologram recording medium 15.

On the other hand, laser light (e.g., P-polarization component) having passed through the polarization beam splitter 105 is reflected by a mirror 107 and then incident on a spatial filter 112. The laser light expanded by the spatial filter 112 is collimated by a collimation lens 114 to be parallel light and then incident on a mirror 109.

The laser light reflected by the mirror 109 is incident on the liquid crystal panel 125 serving as a spatial light modulation element.

The liquid crystal panel 125 is connected to, for example, a liquid crystal driving part such as a microcomputer. With the control of the liquid crystal driving part, an image of additional information is displayed on the liquid crystal panel 125. Accordingly, besides the reference light described above, the laser light (additional information light) having the additional information superimposed thereon is further applied onto the hologram recording medium 15. Note here that an incident angle θ2 of the laser light incident on the hologram recording medium 15 is set at, for example, 23°.

Here, the additional information is, for example, identification information unique to an individual image recording medium. Examples of such identification information include serial numbers, one-dimensional barcodes, and two-dimensional barcodes.

On the emitting surface of the liquid crystal panel 125, a polarization plate 127 is arranged. The polarization plate 127 is arranged to enhance the interference between the additional information light and the reference light.

For example, when the reference light serves as S-polarization with respect to a reflection surface inside the polarization beam splitter 105 and the light incident on the liquid crystal panel 125 serves as P-polarization, the polarization plane of the light incident on the liquid crystal panel 125 is rotated by the liquid crystal panel 125 from P-polarization to S-polarization. At this time, the polarization plate 127 causes only the S-polarization (additional information light) to pass through.

The additional information light having passed through the polarization plate 127 is incident on the hologram recording medium 15 via an image formation optical system 129 composed of a projection lens 121, a diaphragm (mask) 122, and a projection lens 123. Accordingly, an interference pattern formed by the interference between the additional information light and the reference light is recorded on the hologram recording medium 15. In other words, besides the first image, the additional information (second image) made different for an individual image recording medium is recorded on the hologram recording medium 15 as a hologram image, for example.

The range of an eyepoint where the second image can be observed is defined by a diffusion angle of the additional information light. In the configuration example shown in FIG. 13, the image formation optical system 129 controls the diffusion angle of the additional information light. That is, the image formation optical system 129 controls the range of the eyepoint where the second image can be observed.

Note that in the configuration example shown in FIG. 13, a diffusion plate 131 and a louver 17 are arranged one by one between the image formation optical system 129 and the hologram recording medium 15. The diffusion plate 131 may be arranged between the mirror 109 and the liquid crystal panel 125.

The louver 17 interposed between the diffusion plate 131 and the hologram master 10 is arranged to prevent unnecessary reflection light from being incident on the hologram master 10.

The louver 17 has black planar absorption layers arranged inside its transparent plate at constant intervals. The absorption layers of the louver 17 allow the additional information light to pass through to the hologram master 10 and prevent the reference light from passing through to the diffusion plate 131.

With the arrangement of the louver 17 between the diffusion plate 131 and the hologram master 10, it is possible to prevent the reference light reflected at the interface between the hologram master 10 and air from returning to the hologram master 10.

In the manner described above, the replication of a hologram image having continuous parallax in the horizontal direction and the recording of a two-dimensional image having parallax in the vertical direction and serving as a hologram are performed on the hologram recording medium 15.

After the replication of the hologram image and the recording of the two-dimensional image, after-treatment processes such as fixation and cutting of the hologram image are performed on the hologram recording medium 15.

Through the processes described above, the image recording medium is obtained where the hologram image having continuous parallax in the horizontal direction and the two-dimensional image having parallax in the vertical direction and serving as a hologram are recorded. Each image recording medium obtained by the hologram replicating apparatus 101 is an image recording medium that has, for example, a serial number having parallax in the vertical direction and serving as a hologram image besides a hologram image having continuous parallax in the horizontal direction as a common image.

On the image recording medium, the hologram image having continuous parallax in the horizontal direction and the two-dimensional image having parallax in the vertical direction and serving as a hologram are recorded in a material of one layer by refractive index modulation. If the intensity of light for reproducing the two-dimensional image is distributed such that it becomes gradually smaller as the deviation of the angle at which the two-dimensional image is reproduced with maximum brightness becomes larger, an image observed from the image recording medium can be made different from a switching hologram recorded in two steps.

(Position of Two-Dimensional Image)

The positioning of a two-dimensional image at a depth different from that of a hologram image having continuous parallax in the horizontal direction allows an observer to easily distinguish and recognize the hologram image having continuous parallax in the horizontal direction and the two-dimensional image to observe the image recording medium.

Here, if the two-dimensional image is positioned with a greater distance from the front surface of the hologram recording medium, the sharpness of the reproduction image of the two-dimensional image is likely to be reduced. For example, when an image recording medium having a two-dimensional image at a deeper place with respect to the front surface of the image recording medium is observed under illumination from a diffusion light source, the reduced sharpness of the reproduction image of the two-dimensional image results in a difficulty in reading recorded additional information.

In the configuration example shown in FIG. 13, the diffusion plate 131 for increasing the range of the eyepoint where the two-dimensional image (second image) can be observed is interposed between the image formation optical system 129 and the hologram recording medium 15.

The light having passed through the diffusion plate 131 is diffused by an amount corresponding to the thickness of the hologram master 10 before reaching the hologram recording medium 15, which results in a difficulty in positioning the two-dimensional image at a desired place of the hologram recording medium 15. That is, when the diffusion plate 131 is interposed between the image formation optical system 129 and the hologram recording medium 15, a “position shift” occurs in the two-dimensional image.

If the louver 17 is interposed between the diffusion plate 131 and the hologram recording medium 15, the distance between the diffusion plate 131 and the hologram recording medium 15 is increased by an amount corresponding to the thickness of the louver 17.

If the distance between the diffusion plate 131 and the hologram recording medium 15 is large, the sharpness of a reproduction image is reduced and the observer feels as if the two-dimensional image were positioned at a deep place when observing the image recording medium.

For example, when an image recording medium where a “position shift” occurs in a two-dimensional image is observed under illumination from a diffusion light source, the two-dimensional image appears to be blurred. Further, a plurality of ghosts are reproduced from the image recording medium when the image recording medium is illuminated from a plurality of light sources. Moreover, when the image recording medium is observed from a certain direction, part of the two-dimensional image may appear to be interrupted. That is, if a position shift occurs in the two-dimensional image, the observer of the image recording medium has a difficulty in reading recorded additional information.

The present applicants have made the technology of the present disclosure after a great deal of consideration to prevent a “position shift” from occurring in a two-dimensional image.

### (1) First Embodiment

(Configuration Example of Hologram Replicating Apparatus)

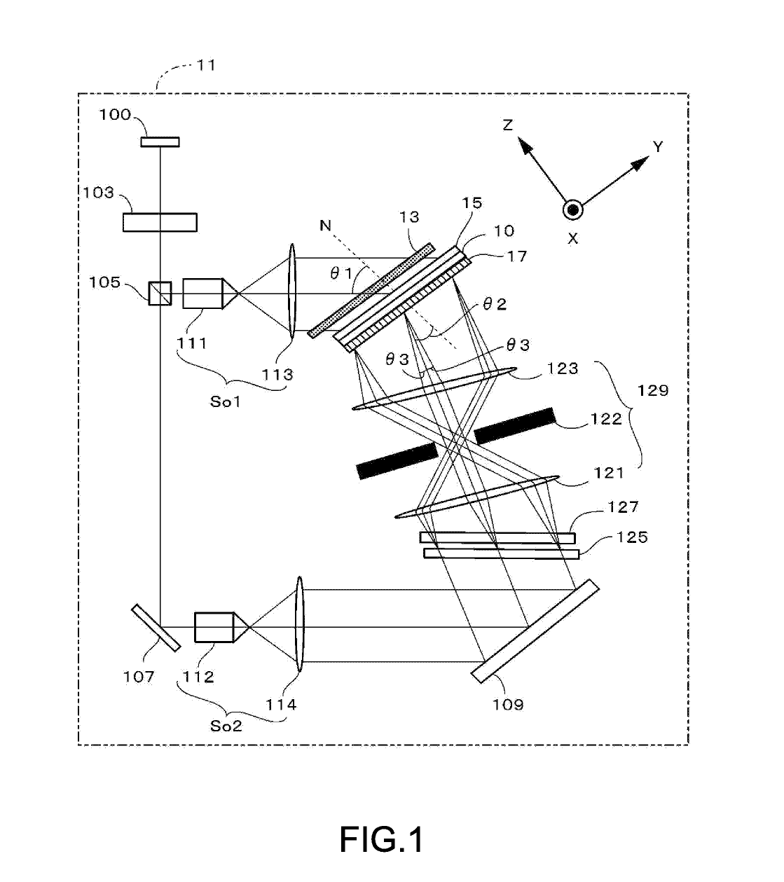

FIG. 1 is a schematic view showing a configuration example of a hologram replicating apparatus according to a first embodiment. As shown in FIG. 1, the hologram replicating apparatus 11 has an optical system for applying reference light onto a hologram recording medium 15 and a hologram master 10 and an optical system for applying additional information light serving as object light onto the hologram recording medium 15.

As shown in FIG. 1, the reference light is generated in such a manner that laser light is emitted from a laser light source 100, passes through a ½ wavelength plate 103, and is branched by a polarization beam splitter 105, for example. One of the branched laser light is applied onto the hologram recording medium 15 and the hologram master 10 as the reference light via a spatial filter 111 and a collimation lens 113. A pair of the spatial filter 111 and the collimation lens 113 constitutes an application optical system So1 for applying the reference light.

The reference light is incident on the hologram recording medium 15 and the hologram master 10 via a diffusion plate 13 arranged between the application optical system So1 and the hologram recording medium 15.

As will be described below, a diffusion plate having the property of diffusing incident light in a specific direction is used in the embodiment of the present disclosure as the diffusion plate 13 arranged between the application optical system So1 and the hologram recording medium 15. The direction where the incident light is diffused is different from the movement direction of an eyepoint where a hologram image having continuous parallax is reproduced from the hologram master 10.

The reference light is incident on the hologram recording medium 15 and the hologram master 10 at the angle θ1 with respect to the normal line N on the hologram recording medium 15.

On the hologram master 10, a hologram image (first image) to be reproduced with illumination from the direction of the incident angle θ1 is recorded. The hologram image is a hologram image to be reproduced with continuous parallax in at least a certain direction when an eyepoint is moved along the certain direction with respect to, for example, the normal line N. The movement direction of the eyepoint where the hologram image is reproduced with continuous parallax from the hologram master 10 is, for example, the horizontal direction of the hologram master 10 (or the horizontal direction of the hologram recording medium 15).

One surface of the hologram master 10 is brought into intimate contact with the hologram recording medium 15 containing a photosensitive material directly or via a refractive index adjuster. Accordingly, when the reference light is applied onto the hologram master 10, the hologram image is reproduced from the hologram master 10 and then the hologram image recorded on the hologram master 10 is replicated on the hologram recording medium 15.

The remaining laser light branched by the polarization beam splitter 105 passes through a spatial filter 112 and a collimation lens 114 and is then incident on a mirror 109. The laser light reflected by the mirror 109 is applied onto the hologram recording medium 15 via a liquid crystal panel 125, a polarization plate 127, and an image formation optical system 129.

As described above, an image of additional information is displayed on the liquid crystal panel 125. For example, in a case where identification information is recorded on the hologram recording medium 15 according to a step and repeat imposition method, a unique serial number, barcode, or the like is displayed on the screen of the liquid crystal panel 125 for each region divided for each surface obtained according to the step and repeat imposition method.

The additional information displayed on the screen of the liquid crystal panel 125 is superimposed on the laser light having passed through the liquid crystal panel 125. By the interference between the laser light (additional information light) having the additional information superimposed thereon and the reference light applied from the application optical system So1, the additional information is recorded on the hologram recording medium 15 as a two-dimensional image.

That is, the additional information light is object light for recording the two-dimensional image in a holographic manner. A pair of the spatial filter 112 and the collimation lens 114 constitutes an application optical system So2 for generating object light.

The additional information light serving as object light is incident on the hologram recording medium 15 at an angle θ2 with respect to the normal line N on the hologram recording medium 15 from the side of the hologram master 10. A louver 17 is arranged to be adjacent to the hologram master 10 if necessary. The arrangement of the louver 17 prevents unnecessary reflection light from being incident on the hologram master 10 and improves the quality of an obtained image recording medium.

By the application of the reference light and the additional information light onto the hologram recording medium 15 at the same time, the hologram image recorded on the hologram master 10 and the additional information are recorded on the hologram recording medium 15.

In the configuration example shown in FIG. 1, the additional information light incident on the hologram recording medium 15 has a diffusion angle θ3. In the configuration example shown in FIG. 1, the reference light is applied onto the hologram recording medium 15 via the diffusion plate 13 when the two-dimensional image of the additional information is recorded. Therefore, when illumination light is applied onto the recorded hologram recording medium 15 from the direction of the incident angle θ1, the diffraction light (reproduction light) related to a two-dimensional image of additional information emitted from the image recording medium is expanded at an angle of ±θ3 or more in the vertical direction centering on the emission angle θ2. Because the diffraction light related to the two-dimensional image of the additional information emitted from the image recording medium is expanded at the angle of ±θ3 or more in the vertical direction, the two-dimensional image of the additional information is observed with the movement of the eyepoint in, for example, the vertical direction if the eyepoint exists in the direction where an angle formed with respect to the normal line N is θ2. As described above, the two-dimensional image of the additional information recorded on the hologram recording medium 15 is a two-dimensional image having parallax in the vertical direction and serving as a hologram.

Accordingly, in the configuration example shown in FIG. 1, a hologram image replicated from the hologram master 10 has continuous parallax in the horizontal direction, and a two-dimensional image of additional information recorded on the hologram recording medium 15 has parallax in the vertical direction.

(Image Recording Medium)

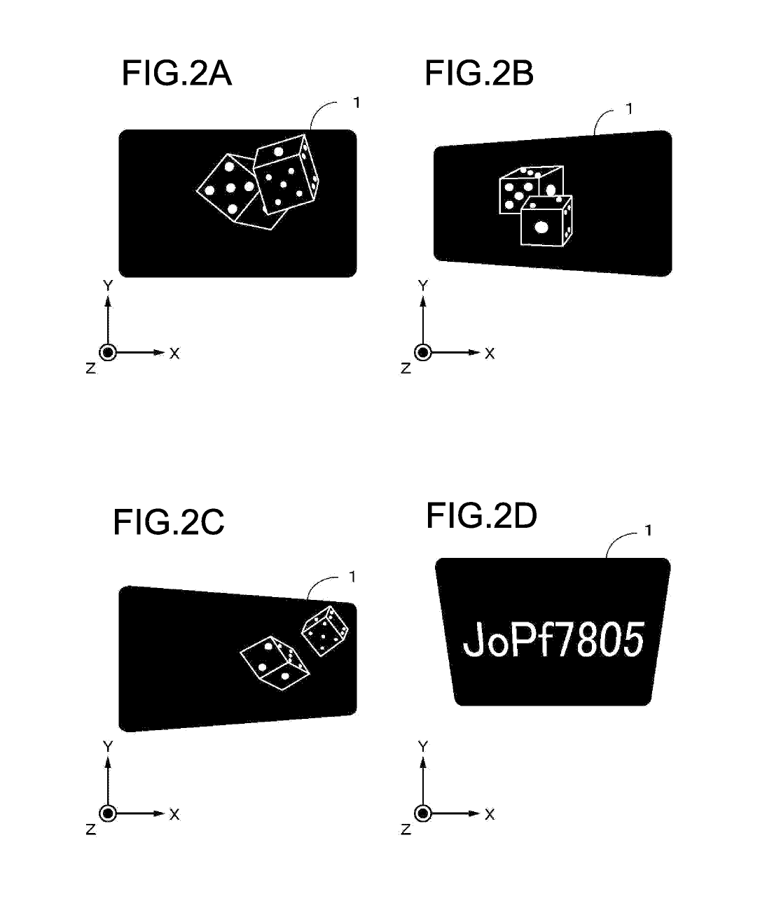

FIGS. 2A to 2D are views each showing an example of a reproduction image reproduced from an image recording medium obtained by the hologram replicating apparatus according to the embodiment of the present disclosure. On the image recording medium 1 obtained by the hologram replicating apparatus 11, a hologram image having continuous parallax in the horizontal direction and a two-dimensional image having parallax in the vertical direction and serving as a hologram are recorded in a material of one layer by refractive index modulation.

For example, when the front side of the image recording medium 1 is observed under illumination light from the direction of the incident angle θ1, an image similar to a hologram image recorded on the hologram master 10 can be observed as shown in FIG. 2A.

Next, it is assumed that an eyepoint for observing the image recording medium 1 is changed along the horizontal direction. Because the hologram image recorded on the hologram master 10 has continuous parallax in the horizontal direction, a reproduction image observed from the image recording medium 1 is also smoothly changed with the change in the eyepoint.

When the eyepoint for observing the image recording medium 1 is moved right, an image different from the image shown in FIG. 2A is observed as shown in, for example, FIG. 2B. When the eyepoint for observing the image recording medium 1 is moved left, an image different from the images shown in FIGS. 2A and 2B is observed as shown in, for example, FIG. 2C. Note that even when the image recording medium 1 is inclined in the horizontal direction with the eyepoint fixed, a reproduction image is smoothly changed as in the case where the eyepoint is moved.

Next, it is assumed that the eyepoint for observing the image recording medium 1 is changed along the vertical direction. Diffraction light related to a two-dimensional image of additional information emitted from the image recording medium 1 is expanded at the angle of ±θ3 or more in the vertical direction. Therefore, the two-dimensional image of the additional information is observed if the eyepoint exists in the direction where an angle formed with respect to the normal line N on the image recording medium 1 is θ2. For example, when the eyepoint for observing the image recording medium 1 is moved up, a two-dimensional image of additional information different from the image shown in FIG. 2A is observed as shown in FIG. 2D.

(Diffusion Plate)

Next, the diffusion plate used in the hologram replicating apparatus according to the embodiment of the present disclosure will be described.

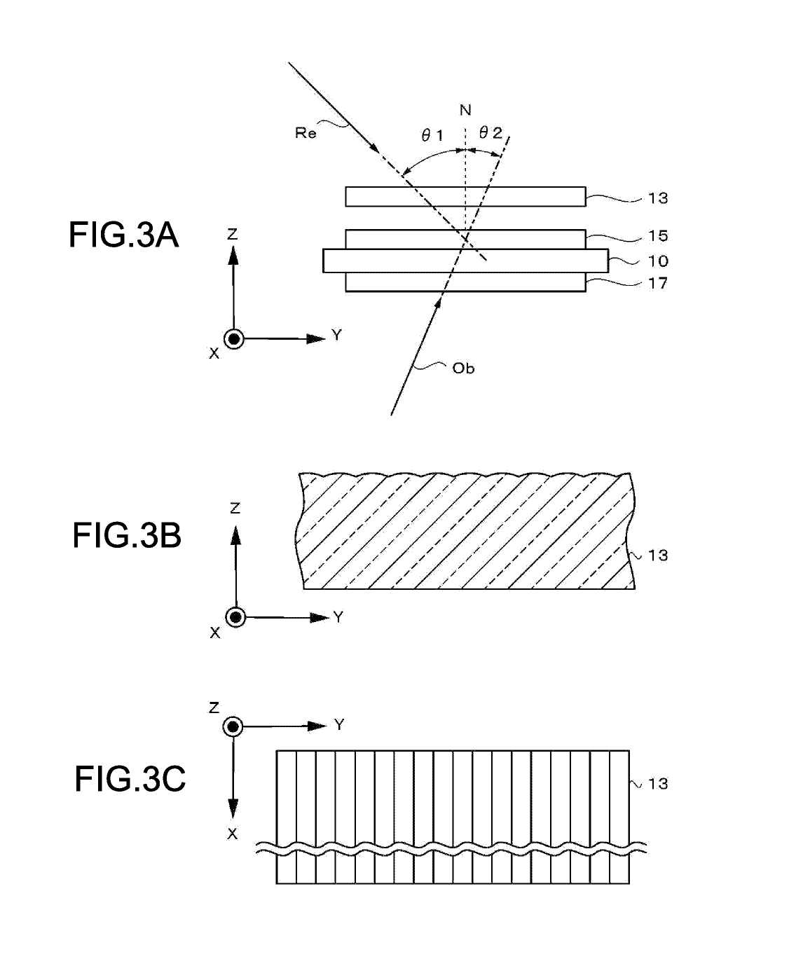

FIG. 3A is a schematic view showing the periphery of the hologram recording medium shown in FIG. 1 in an enlarged manner. In the embodiment of the present disclosure, as shown in FIGS. 1 and 3A, the reference light Re is incident on the hologram recording medium 15 and the hologram master 10 via the diffusion plate 13 arranged between the application optical system So1 and the hologram recording medium 15. In other words, in the configuration example shown in FIGS. 1 and 3A, the diffusion plate is not arranged on a light path on the side where the additional information light Ob is incident on the hologram recording medium 15 unlike the configuration example shown in FIG. 13, but is arranged on a light path on the side where the reference light Re is incident.

In the configuration example shown in FIG. 13, the diffusion plate 131 is arranged on the light path on the side where the additional information light is incident, for the purpose of extending the range of the eyepoint where the two-dimensional image of the additional information can be observed. Accordingly, with the arrangement of the diffusion plate on the side where the reference light is incident, both the range of the eyepoint where the hologram image replicated from the hologram master 10 can be observed and the range of the eyepoint where the two-dimensional image of the additional information can be observed are extended. That is, with the arrangement of the diffusion plate on the side where the reference light is incident, it is possible to extend the range of the eyepoint where the two-dimensional image of the additional information can be observed.

In the embodiment of the present disclosure, a diffusion plate having the property of diffusing incident light in a specific direction (diffusion plate that performs the anisotropic diffusion of the incident light) or a diffusion plate that performs the isotropic diffusion of the incident light is used. The specific direction where the incident light is diffused (hereinafter appropriately referred to as a “second direction”) is a direction different from the movement direction of the eyepoint where the hologram image having continuous parallax is reproduced from the hologram master 10 (hereinafter appropriately referred to as a “first direction”). For example, if the hologram image reproduced from the hologram master 10 has continuous parallax in the horizontal direction (direction along the X axis in FIG. 1), the specific direction where the incident light is diffused by the diffusion plate is the vertical direction (direction along the Y axis in FIG. 1).

As the diffusion plate arranged on the side where the reference light is incident, it is possible to use, for example, an optical element having on the front surface thereof an aggregate of a plurality of structures extending along the movement direction of the eyepoint where the hologram image having continuous parallax is reproduced from the hologram master 10.

FIG. 3B is a schematic view showing the cross section of an example of the diffusion plate applied to the hologram replicating method according to the embodiment of the present disclosure. FIG. 3C is a plan view of the diffusion plate shown in FIG. 3B.

As shown in FIGS. 3B and 3C, specific examples of the diffusion plate arranged on the side where the reference light is incident include a diffusion plate having a plurality of lenticular-shape structures extending in a one-dimensional direction formed on the principal surface thereof (hereinafter appropriately referred to as a “lenticular diffusion plate”). Here, the lenticular shape refers to a circular-arc shape or arc-shape cross section, and the circular-arc shape or the arc-shape also includes a curved shape distorted like a circular-arc or an arc.

The shape of the cross section of the plurality of structures formed on the principal surface is not limited to the lenticular shape, but may be, for example, a prismatic shape, a trapezoidal shape, a rectangular shape, their inverted shapes, or a combination thereof. Further, the plurality of structures may be formed to be adjacent to each other or may be formed to have intervals therebetween.

As the diffusion plate arranged on the side where the reference light is incident, it is also possible to use a so-called holographic diffuser. For example, a holographic diffuser that performs the anisotropic diffusion or isotropic diffusion of the incident light can be used as the holographic diffuser. From the viewpoint of reducing a crosstalk in the first direction (for example, the horizontal direction (direction along the X axis in FIG. 1)) between the hologram image (first image) and the two-dimensional image (second image) of the additional information, it is desirable to use the holographic diffuser that performs the anisotropic diffusion of the incident light as the holographic diffuser. On the other hand, from the viewpoint of improving the visibility of the two-dimensional image (second image) of the additional information, it is desirable to use the holographic diffuser that performs the isotropic diffusion of the incident light as the holographic diffuser.

In a case where the holographic diffuser that performs the anisotropic diffusion of the incident light is used as the holographic diffuser, the holographic diffuser desirably performs the anosotropic diffusion such that the incident light is more widely diffused in the second direction (for example, the vertical direction (direction along the Y axis in FIG. 1)) than in the first direction (for example, the horizontal direction (direction along the X axis in FIG. 1)), and more desirably performs the anisotropic diffusion such that the incident light is diffused approximately only in the second direction.

In a case where the holographic diffuser that performs the anisotropic diffusion of the incident light is used as the holographic diffuser, the holographic diffuser desirably diffuses the incident light at a diffusion angle of 10° or less. This is because the crosstalk between the hologram image (first image) and the two-dimensional image (second image) of the additional information can be reduced within the diffusion angle. Here, the diffusion angle represents the full width at half maximum of the intensity distribution of the emitting light of the holographic diffuser.

The holographic diffuser is an optical element having an approximately-random hologram pattern formed on the front surface thereof. An example of the optical element has been put on the market under the name of “LIGHT SHAPING DIFFUSER (U.S. Registered Trademark No. 85272588 of Luminit LLC)” or “LSD (U.S. Registered Trademark No. 77866052 of Luminit LLC).”

The LSD is an optical element capable of providing high-hemogeneity light diffused at an arbitrary angle with respect to incident light because a hologram pattern formed on a polycarbonate or acrylic sheet acts as a minute lens. For example, an elliptic diffusion (one-dimensional diffusion) holographic diffuser can be used as the diffusion plate arranged on the side where the reference light is incident.

Further, it is also possible to use, as the diffusion plate arranged on the side where the reference light is incident, a transmission hologram where contact printing is performed using a diffusion plate having the property of diffusing incident light in a specific direction as an original plate so long as it can provide satisfactory transmittance.

Note that if the distance between the diffusion plate 13 and the hologram recording medium 15 is too large, the reproduction image reproduced from the image recording medium is likely to be blurred. However, the distance between the diffusion plate 13 and the hologram recording medium 15 can be appropriately adjusted according to the property of the diffusion plate 13.

The hologram recording medium brought into intimate contact with the hologram master directly or indirectly is formed into, for example, a sheet and supplied into the hologram replicating apparatus by intermittent feeding. In this case, the replication of the hologram image and the recording of the additional information are performed one by one in a predetermined hologram recording region of the hologram recording medium supplied into the hologram replicating apparatus. Therefore, the arrangement of the diffusion plate 13 with a certain space from the hologram recording medium 15 is useful for mass production.

In a case where the lenticular diffusion plate is used as the diffusion plate 13, the diffusion plate 13 may be arranged to be brought into intimate contact with the hologram recording medium 15. This is because the smaller the distance between the diffusion plate 13 and the hologram recording medium 15, the greater the sharpness of the reproduction image reproduced from the image recording medium 1 becomes. In this case, every time the replication of the hologram image and the recording of the additional information are completed, it is necessary to separate the diffusion plate 13 from the hologram recording medium 15. However, if information is recorded on the image recording medium 1 according to the step and repeat imposition method, it is possible to reduce the number of separating times of the diffusion plate 13.

In a case where the holographic diffuser is used as the diffusion plate 13, the diffusion plate 13 is desirably arranged with a certain distance from the hologram recording medium 15. This is because the occurrence of image irregularities due to the fine shape pattern of the holographic diffuser can be reduced.

According to the embodiment of the present disclosure, because the diffusion plate is arranged on the side where the reference light is incident, the two-dimensional image of the additional information is formed on an approximately-constant flat surface very close to the front surface of the hologram recording medium. That is, the two-dimensional image can be positioned on the surface of the hologram recording medium. Accordingly, it is possible to prevent the “position shift” of the two-dimensional image at the recording of the hologram and the reduction of the sharpness of the reproduction image.

Moreover, according to the embodiment of the present disclosure, in a case where the diffusion plate having the property of diffusing the incident light into a specific direction is used, the specific direction is different from the movement direction of the eyepoint where the hologram image having continuous parallax is reproduced from the hologram master. Therefore, it is possible to reduce a change in the intensity of the diffraction light of the two-dimensional image with respect to the movements of the eyepoint while preventing the degradation of the reproduction image of the hologram image having continuous parallax. Accordingly, easiness in the observation of an individual image reproduced from the image recording medium can be improved.

Further, according to the embodiment of the present disclosure, in a case where the diffusion plate that performs the isotropic diffusion of the incident light is used, it is possible to improve the visibility of the two-dimensional image (second image) of the additional information compared with a case where the diffusion plate that performs the anisotropic diffusion of the incident light is used.

### (2) Second Embodiment

(Configuration Example of Hologram Replicating Apparatus)

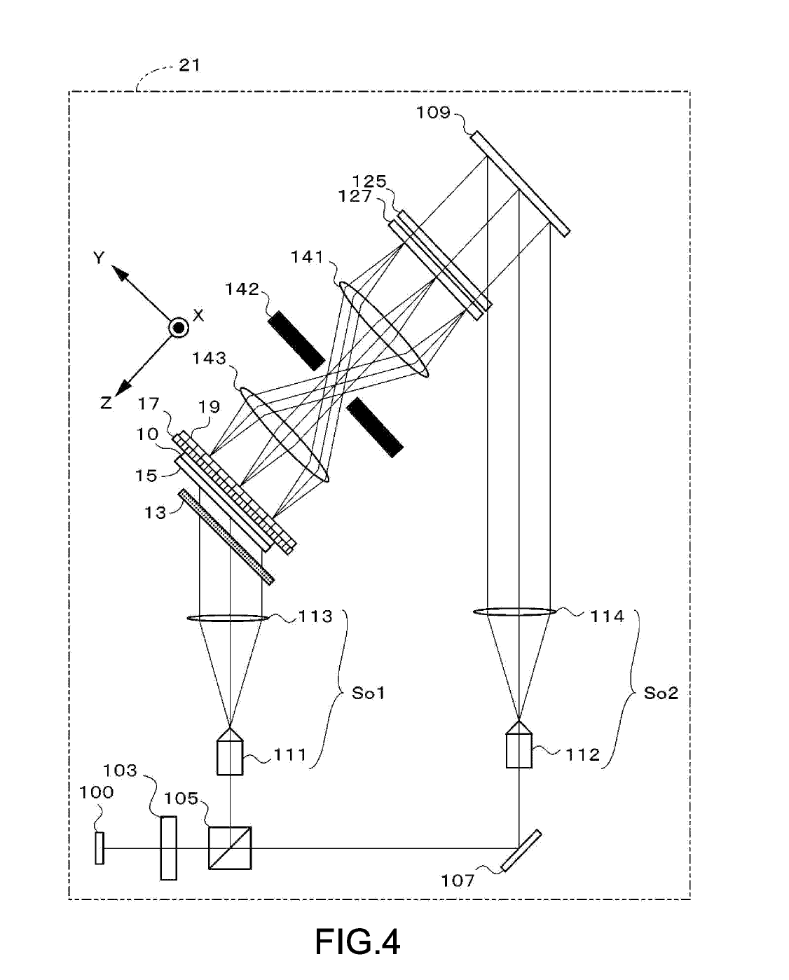

FIG. 4 is a schematic view showing a configuration example of a hologram replicating apparatus according to a second embodiment. As shown in FIG. 4, the second embodiment is common to the first embodiment in that the hologram replicating apparatus 21 has an optical system for applying reference light onto a hologram recording medium 15 and a hologram master 10 and an optical system for applying additional information light serving as object light onto the hologram recording medium 15. On the other hand, the second embodiment is different from the first embodiment in that a display surface of a liquid crystal panel 125 and a principal surface of a polarization plate 127 are arranged to be kept parallel to a principal surface of the hologram master 10 in the hologram replicating apparatus 21.

In the configuration example shown in FIG. 1, the display surface of the liquid crystal panel 125 is inclined with respect to the principal surface of the hologram master 10. In general, the liquid crystal panel 125 is so designed as not to receive light incident from an oblique direction. Therefore, if light is incident on the liquid crystal panel 125 from the oblique direction, a reduction in light use efficiency, a reduction in the homogeneity of light, an increase in scattering light, or the like may occur in the recording of additional information on the hologram recording medium 15.

In view of the problem, in the configuration example shown in FIG. 4, the display surface of the liquid crystal panel 125 and the principal surface of the hologram master 10 are arranged to be kept parallel to each other. At this time, as shown in FIG. 4, additional information light is incident on the hologram master 10 via a projection lens 141, a diaphragm 142, a projection lens 143, a light deflection sheet 19, and a louver 17.

The light deflection sheet 19 is an optical element that deflects the additional information light in a predetermined direction (incident angle). The light deflection sheet 19 is arranged to be adjacent to the hologram master 10 to eliminate a light path difference and create an excellent focusing condition over its entire surface. In the configuration example shown in FIG. 4, the light deflection sheet 19 is arranged to be adjacent to a principal surface of the hologram master 10 on a side opposite to the side where the hologram recording medium 15 is brought into intimate contact. As the light deflection sheet 19, it is possible to use, for example, a holographic optical element, a diffraction optical element, a refractive angle control prism sheet, or the like.

### (3) Third Embodiment

(Configuration Example of Hologram Replicating Apparatus)

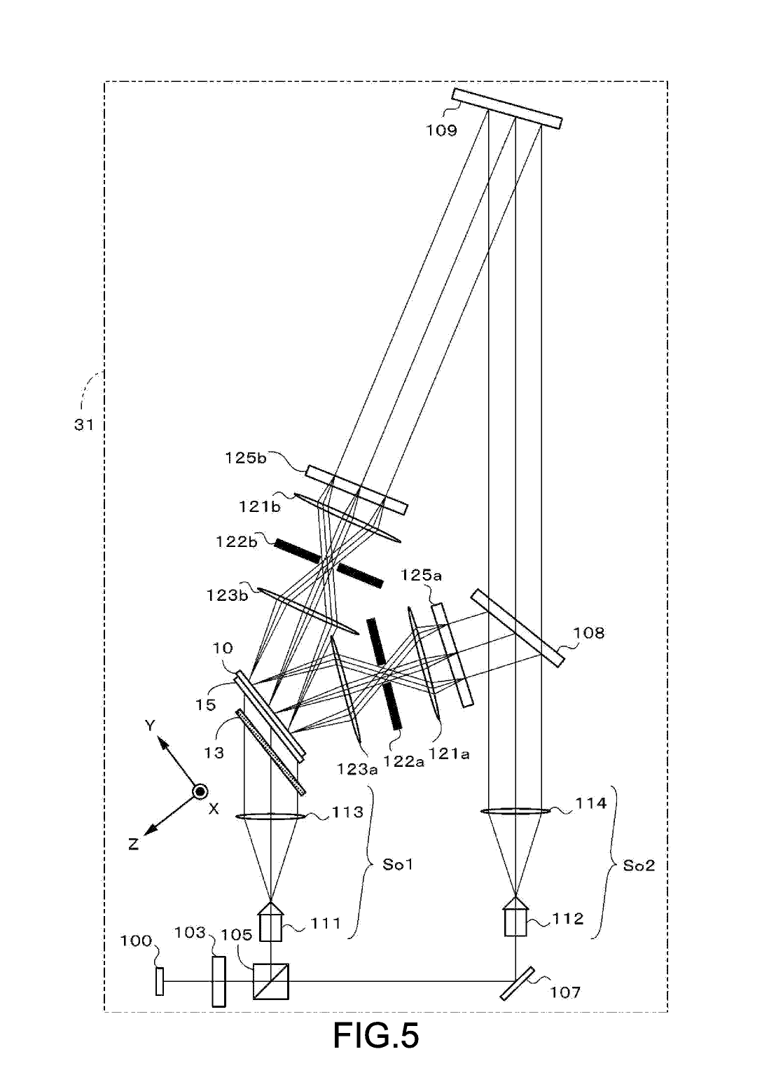

FIG. 5 is a schematic view showing a configuration example of a hologram replicating apparatus according to a third embodiment. In FIG. 5, a polarization plate arranged on the emission surface of a liquid crystal panel is omitted.

As shown in FIG. 5, the third embodiment is common to the first embodiment in that the hologram replicating apparatus 31 has an optical system for applying reference light onto a hologram recording medium 15 and a hologram master 10 and an optical system for applying first additional information light. On the other hand, the third embodiment is different from the first embodiment in that the hologram replicating apparatus 31 has another optical system for applying second additional information light.

According to the third embodiment, laser light emitted from an application optical system So2 is incident on a half-mirror 108. The laser light incident on the half-mirror 108 is branched into reflection light and transmission light.

The laser light reflected by the half-mirror 108 is incident on a liquid crystal panel 125a. On the laser light having passed through the liquid crystal panel 125a, additional information (hereinafter appropriately described as first additional information) displayed on the screen of the liquid crystal panel 125a is superimposed. An image of the first additional information displayed on the liquid crystal panel 125a is formed on the hologram recording medium 15 via an image formation optical system composed of a projection lens 121a, a diaphragm 122a, and a projection lens 123a and the hologram master 10.

On the other hand, the laser light having passed through the half-mirror 108 is reflected by a mirror 109 and then incident on a liquid crystal panel 125b. On the laser light having passed through the liquid crystal panel 125b, additional information (hereinafter appropriately described as second additional information) displayed on the screen of the liquid crystal panel 125b is superimposed. An image of the second additional information displayed on the liquid crystal panel 125b is formed on the hologram recording medium 15 via an image formation optical system composed of a projection lens 121b, a diaphragm 122b, and a projection lens 123b and the hologram master 10.

By the application of the reference light, the first additional information light, and the second additional information light onto the hologram recording medium 15 at the same time, the hologram image recorded on the hologram master 10, the first additional information, and the second additional information are recorded on the hologram recording medium 15.

At this time, as shown in FIG. 5, an incident angle of the first additional information light having the first additional information superimposed thereon with respect to the hologram recording medium 15 is made different from an incident angle of the second additional information light having the second additional information superimposed thereon with respect to the hologram recording medium 15. Thus, in observing the image recording medium, it is possible to make an eyepoint where a reproduction image of the first additional information can be observed be different from an eyepoint where a reproduction image of the second additional information can be observed. That is, besides the replication of the hologram image recorded on the hologram master 10, the recording of the two types of additional information corresponding to the two observation directions can be performed on the hologram recording medium 15.

Note that although the reference light and the first or second additional information light have to be applied onto the hologram recording medium 15 at the same time, it may also be possible to apply the reference light and the first additional information light at the same time and then apply the reference light and the second additional information light at the same time. Moreover, it may also be possible to apply three or more additional information light.

### (4) Fourth Embodiment

(Configuration Example of Hologram Replicating Apparatus)

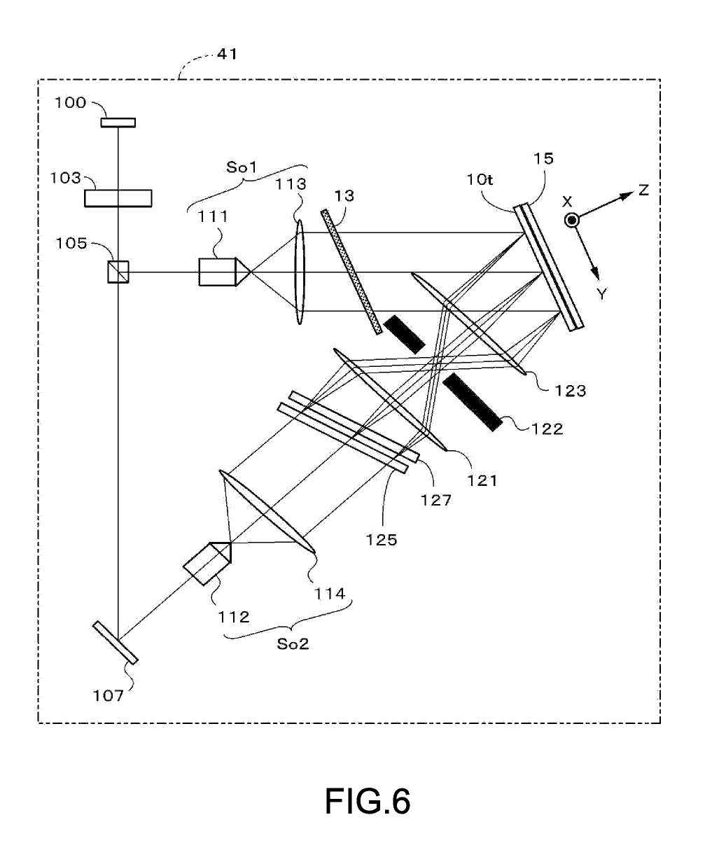

FIG. 6 is a schematic view showing a configuration example of a hologram replicating apparatus according to a fourth embodiment. As shown in FIG. 6, it is also possible to apply a technology according to the embodiment of the present disclosure to a case where a transmission hologram is used as a hologram master 10t.

As shown in FIG. 6, the hologram master 10t is brought into intimate contact with the hologram recording medium 15 in the hologram replicating apparatus 41.

Reference light is incident on the hologram master 10t and the hologram recording medium 15 via a diffusion plate 13 arranged between an application optical system So1 and the hologram recording medium 15. Further, laser light (additional information light) emitted from an application optical system So2 and having passed through a liquid crystal panel 125 is incident on the hologram recording medium 15 via a polarization plate 127, an image formation optical system composed of a projection lens 121, a diaphragm 122, and a projection lens 123, and the hologram master 10t.

By the application of the reference light and the additional information light onto the hologram recording medium 15 at the same time, a hologram image recorded on the hologram master 10t and a two-dimensional image of additional information are recorded on the hologram recording medium 15.

As shown in FIG. 6, the diffusion plate 13 is arranged at a position where the additional information light is not incident. Therefore, it is possible to extend the range of an eyepoint where a two-dimensional image of additional information can be observed and prevent a “position shift” from occurring when the two-dimensional image of the additional information is recorded on the hologram recording medium 15.

### (5) Fifth Embodiment

(Configuration Example of Hologram Replicating Apparatus)

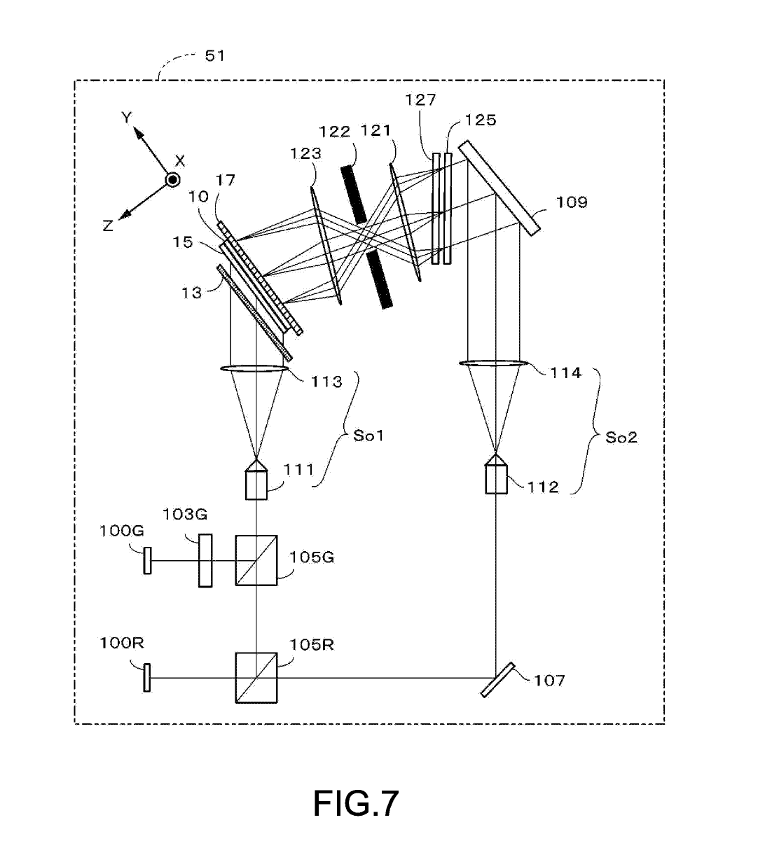

FIG. 7 is a schematic view showing a configuration example of a hologram replicating apparatus according to a fifth embodiment. As shown in FIG. 7, the fifth embodiment is common to the first embodiment in that the hologram replicating apparatus 51 has an optical system for applying reference light onto a hologram recording medium 15 and a hologram master 10 and an optical system for applying additional information light serving as object light onto the hologram recording medium 15. On the other hand, the fifth embodiment is different from the first embodiment in that, when an image recording medium is observed, the color of the reproduction image of a hologram image replicated from the hologram master 10 is made different from that of the reproduction image of a two-dimensional image of additional information.

In order to make the color of the reproduction image of the hologram image reproduced from the image recording medium be different from that of the reproduction image of the two-dimensional image of the additional information reproduced from the image recording medium, a plurality of method can be used. In the configuration example shown in FIG. 7, the wavelength of laser light for replicating the hologram image recorded on the hologram master 10 is made different from that of laser light for recording the two-dimensional image of the additional information to perform multiple exposure.

As shown in FIG. 7, the hologram replicating apparatus 51 has, for example, a green laser (e.g., laser having a wavelength of 532 nm using a semiconductor-excitation second-harmonic wave) light source 100G and a red laser (e.g., HeNe laser having a wavelength of 633 nm) light source 100R. The laser light (hereinafter appropriately referred to as green laser light) emitted from the green laser light source 100G is used for replicating the hologram image recorded on the hologram master 10. On the other hand, the laser light (hereinafter appropriately referred to as red laser light) emitted from the red laser light source 100R is used for recording the two-dimensional image of the additional information.

As shown in FIG. 7, the green laser light emitted from the green laser light source 100G passes through a ½ wavelength plate 103G and is then incident on a polarization beam splitter 105G. On the other hand, as shown in FIG. 7, the red laser light emitted from the red laser light source 100R is incident on a polarization beam splitter 105R to be branched into two laser light. At this time, for example, a component reflected by the polarization beam splitter 105R is incident on the polarization beam splitter 105G and then combined with the green laser light incident on the polarization beam splitter 105G.

The laser light incident on the polarization beam splitter 105G and combined with the green laser light is applied onto the hologram recording medium 15 and the hologram master 10 as the reference light via a spatial filter 111, a collimation lens 113, and a diffusion plate 13.

A component of the red laser light having passed through the polarization beam splitter 105R is reflected by a mirror 107, passes through a spatial filter 112 and a collimation lens 114, and is incident on a mirror 109.

The laser light reflected by the mirror 109 is incident on a liquid crystal panel 125 serving as a spatial light modulation element, and is then caused to have additional information superimposed thereon. The laser light having the additional information superimposed thereon and having passed through a polarization plate 127 is applied onto the hologram recording medium 15 as object light via an image formation optical system composed of a projection lens 121, a diaphragm 122, and a projection lens 123, a louver 17, and the hologram master 10.

On the hologram recording medium 15, an interference pattern formed by the interference between the reference light and diffraction light (reproduction light) emitted from the hologram master 10 when the reference light is applied and an interference pattern formed by the interference between the additional information light and the reference light are recorded. In the manner described above, a green image (replication image of the hologram image recorded on the hologram master 10) and a red image (two-dimensional image of the additional information) are recorded on the hologram recording medium 15. Note that the red image and the green image may be recorded at the same time or may be recorded one by one.

According to the fifth embodiment, the color of the reproduction image of a hologram image reproduced from the image recording medium can be made different from that of the reproduction image of a two-dimensional image of additional information reproduced from the image recording medium. As a result, the difference between the reproduction image of the hologram image and the reproduction image of the two-dimensional image can be further distinguished. Note that the present applicants took statistics from 30 subjects and came to the conclusion that if wavelengths corresponding to the peaks of the intensity of the diffraction light related to the respective two images are different by, for example, 25 nm or more, the two images can be easily observed under the illumination of white light because their colors are separated from each other.

### EXAMPLES

Hereinafter, the embodiments of the present disclosure will be described in detail based on examples, but they are not particularly limited to the examples.

In the following examples, samples of image recording media manufactured by varying the arrangement and specifications of the diffusion plate in the hologram replicating apparatus were prepared. Moreover, for each of the prepared samples, a recorded image was reproduced from the image recording medium under predetermined illumination light, and the brightness of the image recording medium was measured. By the measurement of the brightness of the image recording medium, the intensity of the diffraction light of a hologram image replicated from the hologram master and a two-dimensional image of additional information was evaluated.

(Preparation of Samples)

First, samples were manufactured using a lenticular diffusion plate as the diffusion plate and evaluated.

(Sample 1)

First, based on the same configuration as that of the hologram replicating apparatus shown in FIG. 4, the replication of a hologram image recorded on a hologram master and the recording of a two-dimensional image of additional information were performed on a hologram recording medium to provide a sample 1 of an image recording medium. Note that the distance between the diffusion plate and the hologram master in the hologram replicating apparatus was set to 90 mm. Further, a prism sheet having a refractive angle of 23° was used as a light deflection sheet.

In manufacturing the sample 1 of the image recording medium, a diffusion plate having a plurality of lenticular-shape structures extending in a one-dimensional direction formed on the principal surface thereof was used as a diffusion plate.

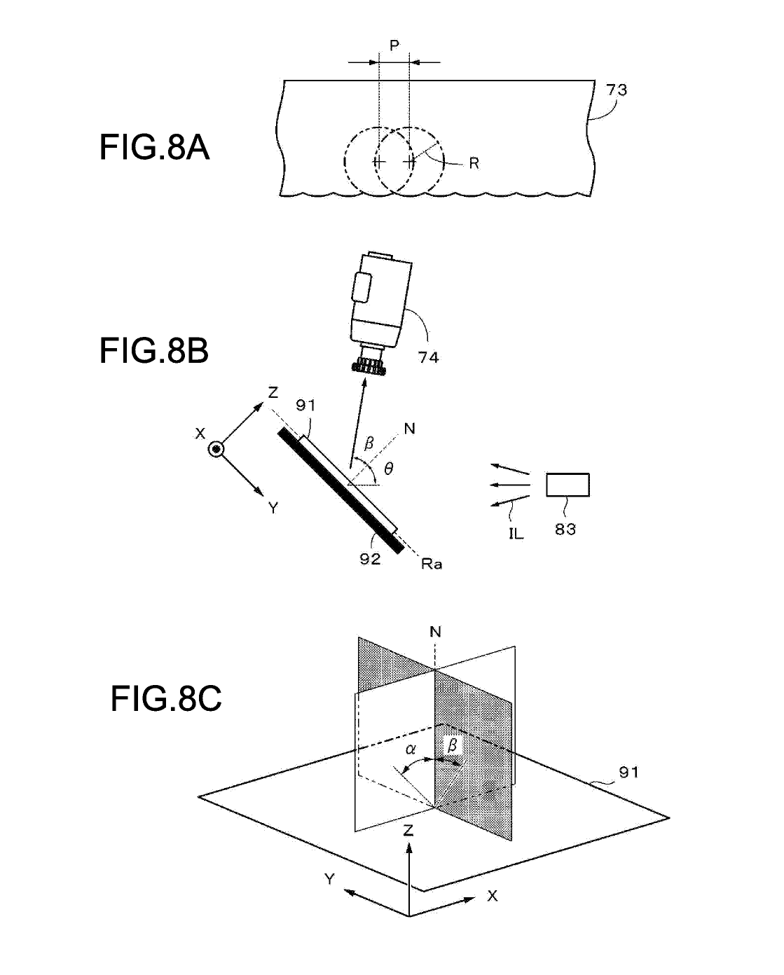

The specifications of the diffusion plate having the plurality of lenticular-shape structures can be expressed, when each unit of the curved surface of a lenticular shape is regarded as part of a circle, by a radius R of the circle and a distance (pitch) P between the centers of the circles of the adjacent lenticular shapes. FIG. 8A shows the relationship between the plurality of lenticular shapes and shape parameters in the diffusion plate 73 having the plurality of lenticular-shape structures.

The values of the shape parameters R and P of the diffusion plate used for manufacturing the sample 1 of the image recording medium are indicated as follows.

R: 0.12 mm

P: 0.019 mm

(Sample 2)

Next, a sample 2 of an image recording medium was manufactured as in the sample 1, except that a diffusion plate having different shape parameters was used.

The values of the shape parameters R and P of the diffusion plate used for manufacturing the sample 2 of the image recording medium are indicated as follows.

R: 0.12 mm

P: 0.038 mm

(Sample 3)

Next, the replication of a hologram image recorded on a hologram master and the recording of a two-dimensional image of additional information were performed on a hologram recording medium to provide a sample 3 of an image recording medium as in the samples 1 and 2, except that a diffusion plate was not arranged. That is, the hologram replicating apparatus used for manufacturing the sample 3 of the image recording medium was so configured as not to have the diffusion plate of the hologram replicating apparatus shown in FIG. 4.

(Evaluation of Intensity of Diffraction Light)

Next, the brightness of the respective samples was measured in different observation directions under predetermined illumination light to evaluate the intensity of the diffraction light of images reproduced from the respective samples.

Here, the intensity of the diffraction light was measured according to the following method.

FIGS. 8B and 8C are schematic views showing the method of measuring the intensity of the diffraction light. As shown in FIG. 8B, the image recording medium was arranged on a black sheet 92 as a measurement object 91. The arrangement of the measurement object 91 on the black sheet 92 aimed to reduce a measurement error caused by a transparent background when the diffraction light (reproduction light) emitted from the measurement object 91 was measured.

A measurement apparatus 74 was arranged with a distance of 380 mm from the measurement object 91. Note that the measurement apparatus 74 was set to have a view of 0.2° for the measurement of the brightness of the image recording medium.

A light source 83 was arranged at a position separated by 280 mm along a predetermined direction from the measurement object 91. The light source 83 was so arranged as to form a predetermined angle θ between a normal line N on the front surface of the measurement object 91 and the light axis of light incident from the light source 83. The predetermined angle is, for example, 45°.

The measurement apparatus 74 and the light source 83 used in the measurement are indicated as follows.

Measurement apparatus: Color brightness meter (Konica-Minolta CS-200)

Light source (white light source): Halogen light source (Y is 96.0, x is 0.4508, and y is 0.4075 on Yxy chromaticity diagram)

As shown in FIG. 8, the illumination light IL emitted from the light source 83 was incident on the measurement object 91. Part of the illumination light IL applied onto the measurement object 91 was diffracted by the measurement object 91 and caused to reach the measurement apparatus 74 to provide data on the brightness of the respective samples.

The measurement of the diffraction light was conducted for each of a hologram image replicated from the hologram master and a two-dimensional image of additional information. In order to change the intensity of the diffraction light when an eyepoint was moved along an X direction (horizontal direction), the measurement object 91 was inclined horizontally using an axis Ra passing through the center of the measurement object 91 shown in FIG. 8B as a rotation axis to change an angle α shown in FIG. 8C. Further, in order to change the intensity of the diffraction light when the eyepoint was moved along a Y direction (vertical direction), the measurement apparatus 74 was rotated within a YZ plane with respect to the measurement object 91 to change an angle β between a line connecting the measurement object 91 to the measurement apparatus 74 and the normal line N.

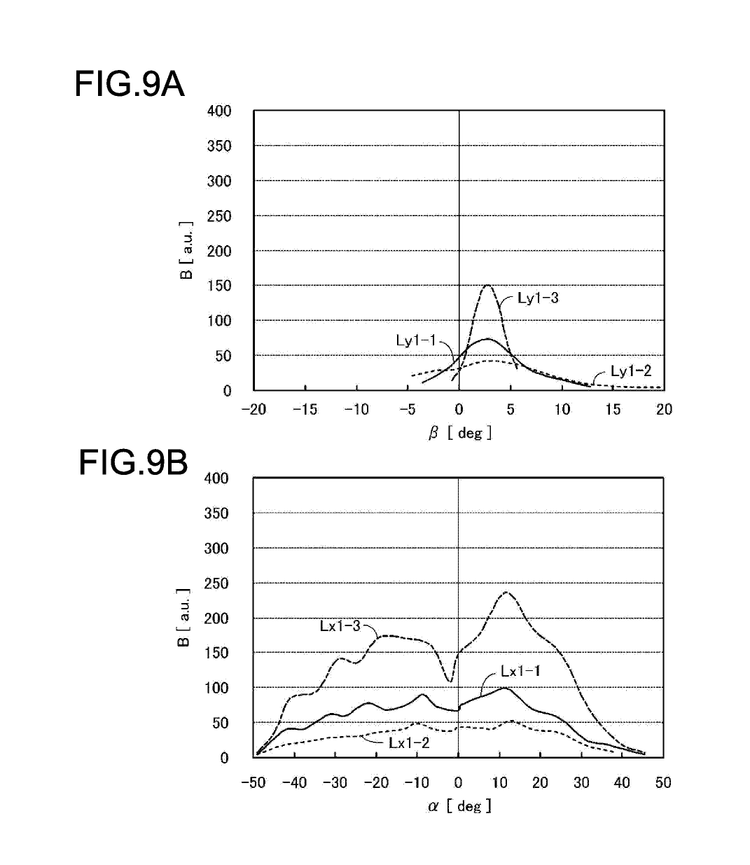

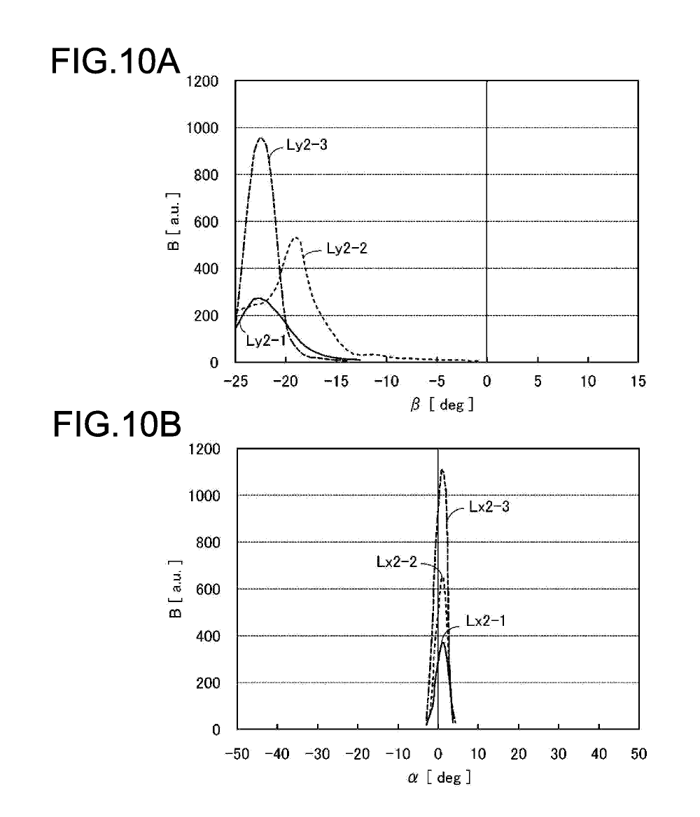

The measurement results of the brightness related to the respective samples are shown in FIGS. 9A and 9B and FIGS. 10A and 10B. Here, [a.u.] in the graphs of the FIGS. 9A and 9B and FIGS. 10A and 10B represents an arbitrary unit. Note that the measurement results shown in FIGS. 9A and 9B and FIGS. 10A and 10B are measurement results on white-printed parts in the measurement object 91.

FIG. 9A is a graph where the horizontal axis is defined as the angle β [deg] within the YZ plane and the vertical axis is defined as the brightness B [a.u.] related to the hologram image replicated from the hologram master. In FIG. 9A, the measurement result on the sample 1 is indicated by a solid line Ly1-1, the measurement result on the sample 2 is indicated by dashed lines Ly1-2, and the measurement result on the sample 3 is indicated by dashed lines Ly1-3.

FIG. 9B is a graph where the horizontal axis is defined as the angle α [deg] within the ZX plane and the vertical axis is defined as the brightness B [a.u.] related to the hologram image replicated from the hologram master. In FIG. 9B, the measurement result on the sample 1 is indicated by a solid line Lx1-1, the measurement result on the sample 2 is indicated by dashed lines Lx1-2, and the measurement result on the sample 3 is indicated by dashed lines Lx1-3.

FIG. 10A is a graph where the horizontal axis is defined as the angle β [deg] within the YZ plane and the vertical axis is defined as the brightness B [a.u.] related to the two-dimensional image of the additional information. In FIG. 10A, the measurement result on the sample 1 is indicated by a solid line Ly2-1, the measurement result on the sample 2 is indicated by dashed lines Ly2-2, and the measurement result on the sample 3 is indicated by dashed lines Ly2-3.

FIG. 10B is a graph where the horizontal axis is defined as the angle α [deg] within the ZX plane and the vertical axis is defined as the brightness B [a.u.] related to the two-dimensional image of the additional information. In FIG. 10B, the measurement result on the sample 1 is indicated by a solid line Lx2-1, the measurement result on the sample 2 is indicated by dashed lines Lx2-2, and the measurement result on the sample 3 is indicated by dashed lines Lx2-3.

FIGS. 9A and 9B reveal the following facts.

According to the configuration of the present disclosure, it is found that the range of the eyepoint where the hologram image (first image) replicated from the hologram matter can be observed is slightly extended in the Y direction, while the range of the eyepoint where the image can be observed is maintained in the X direction. Note that when the samples 1 and 2 of the image recording media were visually observed under illumination light from a predetermined direction, the first images reproduced from the image recording media were clearly confirmed.

FIGS. 10A and 10B reveal the following facts.

When the measurement results of the samples 1 and 2 are compared with the measurement result of the sample 3, it is found that the range of the eyepoint where the two-dimensional image (second image) of the additional information can be observed is extended in the Y direction in the samples 1 and 2 of the image recording media. That is, according to the configuration of the present disclosure, it is found that the range of the eyepoint where the two-dimensional image (second image) of the additional information can be observed is extended in the Y direction and that a change in the intensity of the diffraction light of the image with respect to a change in the observation direction is reduced. It is also found that the range of the eyepoint where the second image can be observed is not greatly changed in the X direction.

Accordingly, it is found that when the diffusion plate having the property of diffusing the incident light into a specific direction is arranged on the side where the reference light is incident with respect to the hologram recording medium, the change in the intensity of the diffraction light of the second image with respect to the movements of the eyepoint can be reduced.

FIGS. 9A and 10A reveal the following facts.

It is found from the measurement results on the samples 1 and 2 that the range of the eyepoint where the first image can be observed is not overlapped with the range of the eyepoint where the second image can be observed and that the crosstalk between the first image and the second image in the Y direction can be prevented according to the configuration of the present disclosure.

Note that when the samples 1 and 2 of the recording media were observed under the illumination light from a predetermined direction, the second images reproduced from the image recording media were clearly confirmed. That is, it is found that the second images reproduced from the image recording media are positioned on the surfaces of the image recording media and that the “position shift” of the second images can be prevented according to the configuration of the present disclosure.

(Preparation of Samples)

Samples were manufactured using a holographic diffuser as the diffusion plate and evaluated.

(Sample 4)

First, based on the same configuration as that of the hologram replicating apparatus shown in FIG. 4, the replication of a hologram image recorded on a hologram master and the recording of a two-dimensional image of additional information were performed on a hologram recording medium to provide a sample 4 of an image recording medium. Note that the distance between the diffusion plate and the hologram master in the hologram replicating apparatus was set to 90 mm. Further, a prism sheet having a refractive angle of 23° was used as a light deflection sheet.

An elliptic diffusion (anisotropic diffusion) holographic diffuser was used as the diffusion plate. The used holographic diffuser has the diffusion characteristics as follows.

Diffusion angle in the vertical direction (direction along the Y axis in FIG. 1): 10°

Diffusion angle in the horizontal direction (direction along the X axis in FIG. 1): 1°

Here, each of the diffusion angles represents the full width at half maximum of the intensity distribution of the emitting light of the holographic diffuser.

(Sample 5)

A sample 5 of an image recording medium was manufactured as in the sample 1, except that a circle diffusion (isotropic diffusion) holographic diffuser was used as the diffusion plate.

The used holographic diffuser has the diffusion characteristics as follows.

Diffusion angle: 5°

Here, the diffusion angle represents the full width at half maximum of the intensity distribution of the emitting light of the holographic diffuser.

(Sample 6)

The replication of a hologram image recorded on a hologram master and the recording of a two-dimensional image of additional information were performed on a hologram recording medium to provide a sample 6 of an image recording medium as in the samples 3 and 4, except that a diffusion plate was not arranged. That is, the hologram replicating apparatus used for manufacturing the sample 6 of the image recording medium was so configured as not to have the diffusion plate of the hologram replicating apparatus shown in FIG. 4.

(Evaluation of Intensity of Diffraction Light)

The intensity of the diffraction light of the samples 4 to 6 thus manufactured was evaluated as in the samples 1 to 3.

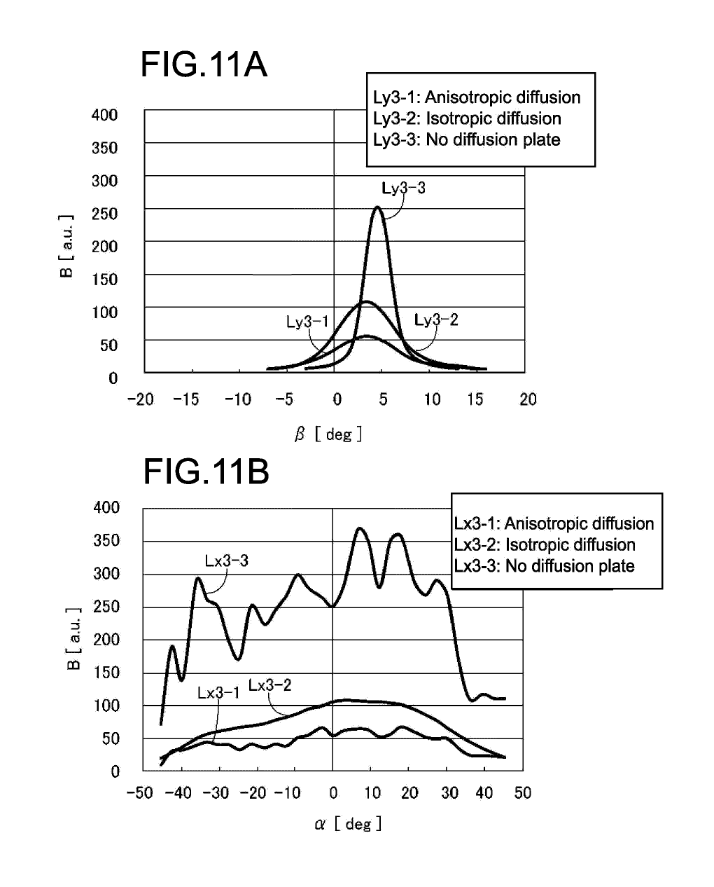

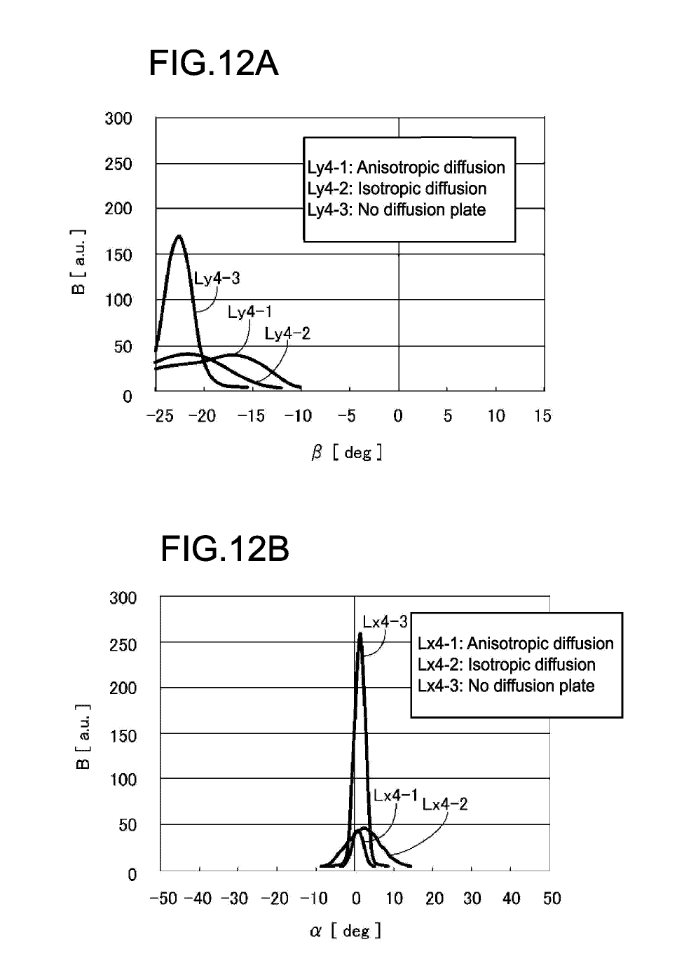

The measurement results of brightness related to the respective samples are shown in FIGS. 11A and 11B and FIGS. 12A and 12B. Here, [a.u.] in the graphs of the FIGS. 11A and 11B and FIGS. 12A and 12B represents an arbitrary unit. Note that the measurement results shown in FIGS. 11A and 11B and FIGS. 12A and 12B are measurement results on white-printed parts in the measurement object 91.

FIG. 11A is a graph where the horizontal axis is defined as the angle β [deg] within the YZ plane and the vertical axis is defined as the brightness B [a.u.] related to the hologram image replicated from the hologram master. In FIG. 11A, the measurement result on the sample 4 is indicated by a solid line Ly3-1, the measurement result on the sample 5 is indicated by a solid line Ly3-2, and the measurement result on the sample 6 is indicated by a solid line Ly3-3.

FIG. 11B is a graph where the horizontal axis is defined as the angle α [deg] within the ZX plane and the vertical axis is defined as the brightness B [a.u.] related to the hologram image replicated from the hologram master. In FIG. 11B, the measurement result on the sample 4 is indicated by a solid line Lx3-1, the measurement result on the sample 5 is indicated by a solid line Lx3-2, and the measurement result on the sample 6 is indicated by a solid line Lx3-3.

FIG. 12A is a graph where the horizontal axis is defined as the angle β [deg] within the YZ plane and the vertical axis is defined as the brightness B [a.u.] related to the two-dimensional image of the additional information. In FIG. 12A, the measurement result on the sample 4 is indicated by a solid line Ly4-1, the measurement result on the sample 5 is indicated by a solid line Ly4-2, and the measurement result on the sample 6 is indicated by a solid line Ly4-3.

FIG. 12B is a graph where the horizontal axis is defined as the angle α [deg] within the ZX plane and the vertical axis is defined as the brightness B [a.u.] related to the two-dimensional image of the additional information. In FIG. 12B, the measurement result on the sample 4 is indicated by a solid line Lx4-1, the measurement result on the sample 5 is indicated by a solid line Lx4-2, and the measurement result on the sample 6 is indicated by a solid line Lx4-3.

FIGS. 11A and 11B reveal the following facts.

In the samples 4 and 5 of the image recording media, it is found that the range of the eyepoint where the hologram image (first image) replicated from the hologram matter can be observed is slightly extended in the Y direction, while the range of the eyepoint where the image can be observed is maintained in the X direction. Note that when the samples 4 and 5 of the image recording media were visually observed under illumination light from a predetermined direction, the first images reproduced from the image recording media were clearly confirmed.

FIGS. 12A and 12B reveal the following facts.

When the measurement results of the samples 4 and 5 are compared with the measurement result of the sample 6, it is found that the range of the eyepoint where the two-dimensional image (second image) of the additional information can be observed is extended in the Y direction in the samples 4 and 5 of the image recording media. That is, according to the configuration of the present disclosure, it is found that the range of the eyepoint where the two-dimensional image (second image) of the additional information can be observed is extended in the Y direction and that a change in the intensity of the diffraction light of the image with respect to a change in the observation direction is reduced. As for the sample 5, it is also found that the change in the intensity of the diffraction light is reduced in the X direction.

Accordingly, it is found that with the arrangement of the diffusion plate that performs the anisotropic diffusion or isotropic diffusion of the incident light on the side where the reference light is incident with respect to the hologram recording medium, the change in the intensity of the diffraction light of the second image with respect to the movements of the eyepoint can be reduced.

FIGS. 11A and 12A reveal the following facts.

It is found from the measurement result on the sample 4 that the range of the eyepoint where the first image can be observed is not overlapped with the range of the eyepoint where the second image can be observed and that the crosstalk between the first image and the second image in the Y direction can be prevented according to the configuration of the present disclosure.

That is, it is found that, even in a case where the diffusion plate that performs the isotropic diffusion of the incident light is used, the crosstalk between the first image and the second image can be prevented if a diffusion angle is small (if the diffusion angle is within 10°) as in a case where the diffusion plate that performs the anisotropic diffusion of the incident light is used.

In the sample 5, it is found that the effect of preventing the crosstalk is slightly less than that of the sample 4 but the effect of improving the visibility of the two-dimensional image (second image) of the additional information is greater than that of the sample 4.

Note that when the samples 4 and 5 of the recording media were observed under the illumination light from a predetermined direction, the second images reproduced from the image recording media were clearly confirmed. That is, it is found that the second images reproduced from the image recording media are positioned on the surfaces of the image recording media and that the “position shift” of the second images can be prevented according to the configuration of the present disclosure.

### (6) Modification

The desired embodiments are described above. However, the desired concrete examples are not limited to the examples described above and may be modified in various ways.

For example, as additional information, image information other than identification information such as serial numbers, manufacturer's names, lot numbers, one-dimensional barcodes, and two-dimensional barcodes can be recorded.

Further, the desired embodiments describe the configuration example where the liquid crystal panel is used as a spatial light modulation element. However, an element other than the liquid crystal panel may be used. The additional information may be projected on the front surface of the liquid crystal panel in an enlarged or reduced manner.

Note that the configurations, methods, shapes, processes, materials, numerical values, and the like described in the above embodiments are for illustrative purposes only, and thus different configurations, methods, shapes, processes, materials, numeric values, and the like may be used if necessary. The configurations, methods, shapes, processes, materials, numeric values, and the like of the embodiments described above may be combined together without departing from the spirit of the present disclosure.

For example, the present disclosure may also employ the following configurations.

(1) A hologram replicating method, including:

bringing a hologram master having a hologram image recorded thereon into intimate contact with a surface of a hologram recording medium containing a photosensitive material directly or via a refractive index adjuster, the hologram image being made to have continuous parallax in at least a first direction with a movement of an eyepoint along the first direction with respect to a normal line when the hologram master is illuminated at a predetermined angle;

applying first laser light onto the hologram master and the hologram recording medium via a diffusion plate configured to diffuse incident light in a second direction and applying second laser light having passed through a first spatial light modulation element configured to modulate incident light based on first additional information onto the hologram recording medium via the hologram master simultaneously with the first laser light; and

recording the hologram image recorded on the hologram master and the first additional information on the hologram recording medium.

(2) The hologram replicating method according to (1), further including arranging a light deflection element to be adjacent to a principal surface of the hologram master on a side opposite to a side where the hologram recording medium is brought into intimate contact.

(3) The hologram replicating method according to (1) or (2), in which

the diffusion plate is arranged with a space from the hologram recording medium.

(4) The hologram replicating method according to any one of (1) to (3), in which

a front surface of the diffusion plate has an arrangement of lenticular-shape structures extending in the first direction.

(5) The hologram replicating method according to any one of (1) to (4), in which

the hologram recording medium includes a hologram recording medium configured to record information as a volume hologram.

(6) The hologram replicating method according to any one of (1) to (5), in which

the first additional information includes identification information.

(7) The hologram replicating method according to any one of (1) to (6), in which

the hologram image recorded on the hologram master includes a holographic stereogram.

(8) The hologram replicating method according to any one of (1) to (7), in which

a wavelength of the second laser light is different from a wavelength of light for reproducing the hologram image recorded on the hologram master.

(9) The hologram replicating method according to any one of (1) to (8), in which

a wavelength of the second laser light is different from a wavelength of light for reproducing the hologram image recorded on the hologram master by at least 25 nm or more.

(10) The hologram replicating method according to any one of (1) to (9), further including:

applying third laser light having passed through a second spatial light modulation element configured to modulate incident light based on second additional information onto the hologram recording medium at an incident angle different from an incident angle of the second laser light via the hologram master simultaneously with the first laser light; and

recording the second additional information on the hologram recording medium.

(11) A hologram replicating method, including:

arranging a hologram master having a hologram image recorded thereon with respect to a surface of a hologram recording medium;

applying first laser light onto the hologram master and the hologram recording medium via a diffusion plate;

modulating second laser light based on additional information; and

applying the modulated second laser light onto the hologram recording medium via the hologram master.

(12) The hologram replicating method according to (11), in which

the diffusion plate includes a diffusion plate configured to perform isotropic diffusion of incident light.

(13) The hologram replicating method according to (12), in which

the diffusion plate is configured to perform the isotropic diffusion such that the incident light is diffused at a diffusion angle of 10° or less.

(14) The hologram replicating method according to (11), in which

the diffusion plate includes a diffusion plate configured to perform anisotropic diffusion of incident light.

(15) The hologram replicating method according to (14), in which

the diffusion plate is configured to perform the anisotropic diffusion such that the incident light is more widely diffused in a second direction than in a first direction.

(16) The hologram replicating method according to any one of (11) to (15), in which

the diffusion plate includes a holographic diffuser.

(17) A hologram replicating apparatus, including:

a first application optical system configured to apply first laser light onto a hologram master having a hologram image recorded thereon and a hologram recording medium containing a photosensitive material,
the hologram image being made to have continuous parallax in at least a first direction with a movement of an eyepoint along the first direction with respect to a normal line when the hologram master is illuminated at a predetermined angle,
the hologram recording medium being brought into intimate contact with a surface of the hologram master directly or via a refractive index adjuster;

a diffusion plate arranged between the first application optical system and the hologram recording medium and configured to diffuse incident light in a second direction;

a second application optical system configured to apply second laser light onto the hologram recording medium via the hologram master; and

a spatial light modulation element arranged between the second application optical system and the hologram master and configured to modulate incident light based on additional information, the first laser light and the second laser light being simultaneously applied to record the hologram image recorded on the hologram master and the additional information on the hologram recording medium.

(18) A hologram replicating apparatus, including:

a first application optical system configured to apply first laser light onto a hologram master having a hologram image recorded thereon and a hologram recording medium arranged with respect to a surface of the hologram master;

a diffusion plate arranged between the first application optical system and the hologram recording medium;

a second application optical system configured to apply second laser light onto the hologram recording medium via the hologram master; and

a spatial light modulation element arranged between the second application optical system and the hologram master and configured to modulate incident light based on additional information.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A hologram replicating method, comprising:
bringing a hologram master having a hologram image recorded thereon into intimate contact with a surface of a hologram recording medium containing a photosensitive material directly or via a refractive index adjuster, the hologram image being made to have continuous parallax in at least a first direction with a movement of an eyepoint along the first direction with respect to a normal line when the hologram master is illuminated at a predetermined angle;
applying first laser light onto the hologram master and the hologram recording medium via a diffusion plate configured to diffuse incident light in a second direction and applying second laser light having passed through a first spatial light modulation element configured to modulate incident light based on first additional information onto the hologram recording medium via the hologram master simultaneously with the first laser light; and
recording the hologram image recorded on the hologram master and the first additional information on the hologram recording medium.

2. The hologram replicating method according to claim 1, further comprising arranging a light deflection element to be adjacent to a principal surface of the hologram master on a side opposite to a side where the hologram recording medium is brought into intimate contact.

3. The hologram replicating method according to claim 1, wherein
the diffusion plate is arranged with a space from the hologram recording medium.

4. The hologram replicating method according to claim 1, wherein
a front surface of the diffusion plate has an arrangement of lenticular-shape structures extending in the first direction.

5. The hologram replicating method according to claim 1, wherein
the hologram recording medium includes a hologram recording medium configured to record information as a volume hologram.

6. The hologram replicating method according to claim 1, wherein
the first additional information includes identification information.

7. The hologram replicating method according to claim 1, wherein
the hologram image recorded on the hologram master includes a holographic stereogram.

8. The hologram replicating method according to claim 1, wherein
a wavelength of the second laser light is different from a wavelength of light for reproducing the hologram image recorded on the hologram master.

9. The hologram replicating method according to claim 1, wherein
a wavelength of the second laser light is different from a wavelength of light for reproducing the hologram image recorded on the hologram master by at least 25 nm or more.

10. The hologram replicating method according to claim 1, further comprising:
applying third laser light having passed through a second spatial light modulation element configured to modulate incident light based on second additional information onto the hologram recording medium at an incident angle different from an incident angle of the second laser light via the hologram master simultaneously with the first laser light; and
recording the second additional information on the hologram recording medium.

11. A hologram replicating method, comprising:
arranging a hologram master having a hologram image recorded thereon with respect to a surface of a hologram recording medium;
applying first laser light onto the hologram master and the hologram recording medium via a diffusion plate;
modulating second laser light based on additional information; and
applying the modulated second laser light onto the hologram recording medium via the hologram master.

12. The hologram replicating method according to claim 11, wherein
the diffusion plate includes a diffusion plate configured to perform isotropic diffusion of incident light.

13. The hologram replicating method according to claim 12, wherein
the diffusion plate is configured to perform the isotropic diffusion such that the incident light is diffused at a diffusion angle of 10° or less.

14. The hologram replicating method according to claim 11, wherein
the diffusion plate includes a diffusion plate configured to perform anisotropic diffusion of incident light.

15. The hologram replicating method according to claim 14, wherein
the diffusion plate is configured to perform the anisotropic diffusion such that the incident light is more widely diffused in a second direction than in a first direction.

16. The hologram replicating method according to claim 11, wherein
the diffusion plate includes a holographic diffuser.

17. A hologram replicating apparatus, comprising:
a first application optical system configured to apply first laser light onto a hologram master having a hologram image recorded thereon and a hologram recording medium containing a photosensitive material,
the hologram image being made to have continuous parallax in at least a first direction with a movement of an eyepoint along the first direction with respect to a normal line when the hologram master is illuminated at a predetermined angle,
the hologram recording medium being brought into intimate contact with a surface of the hologram master directly or via a refractive index adjuster;
a diffusion plate arranged between the first application optical system and the hologram recording medium and configured to diffuse incident light in a second direction;
a second application optical system configured to apply second laser light onto the hologram recording medium via the hologram master; and
a spatial light modulation element arranged between the second application optical system and the hologram master and configured to modulate incident light based on additional information, the first laser light and the second laser light being simultaneously applied to record the hologram image recorded on the hologram master and the additional information on the hologram recording medium.

18. A hologram replicating apparatus, comprising:
a first application optical system configured to apply first laser light onto a hologram master having a hologram image recorded thereon and a hologram recording medium arranged with respect to a surface of the hologram master;
a diffusion plate arranged between the first application optical system and the hologram recording medium;
a second application optical system configured to apply second laser light onto the hologram recording medium via the hologram master; and
a spatial light modulation element arranged between the second application optical system and the hologram master and configured to modulate incident light based on additional information.
